(19) United States
(12) Patent Application Publication
(10) Pub. No.: US 2024/0228684 A1
(43) Pub. Date: Jul. 11, 2024

(54) LIQUID CRYSTAL POLYMER FINE PARTICLES, AND METHOD FOR PRODUCING LIQUID CRYSTAL POLYMER FINE PARTICLES

(71) Applicant: The Ritsumeikan Trust, Kyoto-shi, Kyoto (JP)

(72) Inventors: Osamu TSUTSUMI, Kusatsu-shi, Shiga (JP); Kyohei HISANO, Kusatsu-shi, Shiga (JP); Tomoki SHIGEYAMA, Kusatsu-shi, Shiga (JP); Shodai HAYASHI, Kusatsu-shi, Shiga (JP)

(73) Assignee: The Ritsumeikan Trust, Kyoto-shi, Kyoto (JP)

(21) Appl. No.: 18/289,062

(22) PCT Filed: Apr. 28, 2022
(86) PCT No.: PCT/JP2022/019448

§ 371 Date: Oct. 31, 2023

(30) Foreign Application Priority Data
May 7, 2021 (JP) 2021-079160

(51) Int. Cl. C08F 220/36

(52) U.S. Cl. CPC C08F 220/36; C08F 2800/10; C08F 2810/20; C08F 2810/50

(57) ABSTRACT

Variation in the shape and size or disturbance of the molecular orientation of a particle is prevented. A liquid crystal polymer particle of the disclosure has a crosslinked structure in which liquid crystal polymers are crosslinked by a crosslinkable functional group that is not crosslinked in a polymerization reaction for synthesizing the liquid crystal polymer particle. The particle has the crosslinked structure due to a crosslinkable functional group that is not crosslinked in the polymerization reaction.

### TECHNICAL FIELD

The present disclosure relates to a liquid crystal polymer particle and a method for producing the liquid crystal polymer particle. This application claims priority on Japanese Patent Application No. 2021-079160 filed on May 7, 2021, the entire content of which is incorporated herein by reference.

### BACKGROUND ART

PATENT LITERATURE 1 discloses a cholesteric liquid crystal polymer particle. In the liquid crystal polymer particle of PATENT LITERATURE 1, the helical axes are radially orientated from the particle center. That is, in PATENT LITERATURE 1, the molecular orientation of liquid crystals is uniformly controlled.

### CITATION LIST

### Patent Literature

PATENT LITERATURE 1: Japanese Laid-Open Patent Publication No. 2020-139135

### SUMMARY OF INVENTION

As in the case of the liquid crystal polymer particle of PATENT LITERATURE 1, a structure in which the molecular orientation is uniformly controlled in one region is referred to as a monodomain liquid crystal structure. Here, a domain is a region in which a uniform liquid crystal structure is formed. Monodomain means a state where the region in which a uniform liquid crystal structure is formed is one. Since the region in which the molecular orientation is uniformly controlled is one, the liquid crystal polymer particle of PATENT LITERATURE 1 has a monodomain liquid crystal structure. When a large number of domains are present in a particle, the particle has a polydomain liquid crystal structure.

The liquid crystal polymer particle of PATENT LITERATURE 1 exhibits a specific material property such as an optical property according to the liquid crystal molecular orientation.

The present inventors conceived of introducing a crosslinked structure to the liquid crystal polymer particle as described in PATENT LITERATURE 1.

Introduction of the crosslinked structure is advantageous in that, with respect to the liquid crystal polymer particle, external stimulation responsiveness can be adjusted or external environment stability can be provided. The adjustment of external stimulation responsiveness is adjustment of the elasticity of the particle, for example. When the elasticity of the particle is adjusted through crosslinking, the amount of elastic deformation against force (stimulation) applied from outside to the particle can be adjusted. The external environment stability is heat resistance or chemical resistance, for example. Through crosslinking, heat resistance or chemical resistance of the particle can be increased.

However, the present inventors found through an experiment that, when a crosslinked structure is attempted to be introduced to the liquid crystal polymer particle as in PATENT LITERATURE 1, variation in the shape and size of the particle may become large, and the molecular orientation may also be disturbed. That is, introduction of a crosslinked structure has a drawback that properties of the liquid crystal polymer particle are impaired.

Therefore, such problems are desired to be solved.

An aspect of the present disclosure is a liquid crystal polymer particle. The liquid crystal polymer particle of the disclosure has a crosslinked structure in which liquid crystal polymers are crosslinked by a crosslinkable functional group that is not crosslinked in a polymerization reaction for synthesizing the liquid crystal polymer particle.

Another aspect of the present disclosure is a method for producing a liquid crystal polymer particle. The method for producing the liquid crystal polymer particle of the disclosure includes: generating a non-crosslinked liquid crystal polymer particle through a polymerization reaction; and crosslinking, through a crosslinking reaction after the polymerization reaction, the non-crosslinked liquid crystal polymer particle generated through the polymerization reaction. The crosslinking reaction is a different-type-reactivity crosslinking reaction having a reactivity different from that of the polymerization reaction.

Further details will be described as an embodiment described later.

### BRIEF DESCRIPTION OF DRAWINGS

FIG. 1 is a flowchart showing a procedure of a method for producing a liquid crystal polymer particle.

FIG. 2 shows raw materials of the liquid crystal polymer particle and a non-crosslinked liquid crystal polymer particle.

FIG. 3 shows a structure of a liquid crystal polymer synthesized through a polymerization reaction.

FIG. 4 shows a chemical structural formula of the liquid crystal polymer synthesized through the polymerization reaction.

FIG. 5 is a conceptual diagram showing a non-crosslinked liquid crystal polymer particle and a crosslinked liquid crystal polymer particle.

FIG. 6 is POM observation images of the liquid crystal polymer particles.

FIG. 7 is POM observation images of a liquid crystal polymer particle.

FIG. 8 is POM observation images of the liquid crystal polymer particles.

FIG. 9 is SEM observation images of liquid crystal polymer particles according to a reference example.

FIG. 10 is a diagram describing a droplet polymerization type.

FIG. 11 shows chemical structures of compounds that are used in a second production example and a chemical structure of a particle that is obtained.

FIG. 12 shows raw materials in the second production example.

FIG. 13 is an SEM observation image of particles according to the second production example.

FIG. 14 shows chemical structures of compounds that are used in a third production example.

FIG. 15 shows raw materials in the third production example.

FIG. 16 is an SEM observation image of particles according to the third production example.

FIG. 17 is open nicol observation images of particles according to a first crosslinking example.

FIG. 18 is open nicol observation images of particles according to a second crosslinking example.

FIG. 19 is open nicol observation images of particles according to a third crosslinking example.

### DESCRIPTION OF EMBODIMENTS

### <1. Outline of Liquid Crystal Polymer Particle and Method for Producing Liquid Crystal Polymer Particle>

(1) A liquid crystal polymer particle according to an embodiment has a crosslinked structure in which liquid crystal polymers are crosslinked by a crosslinkable functional group that is not crosslinked in a polymerization reaction for synthesizing the liquid crystal polymer particle. Since the particle has the crosslinked structure due to the crosslinkable functional group that is not crosslinked in the polymerization reaction, variation in the shape and size or disturbance of the molecular orientation of the particle can be prevented. The liquid crystal polymer particle is a particle having a liquid crystal property and is composed of a polymer. In the particle, the particle diameter is, for example, not greater than 100 μm, more preferably, the particle diameter is not greater than 50 μm, and further preferably, the particle diameter is not greater than 10 μm.

(2) Preferably, each liquid crystal polymer includes a polymer backbone; a first side chain bound to the polymer backbone; and a second side chain bound to the polymer backbone. The first side chain can include a first mesogenic moiety. The second side chain can include a crosslinking moiety forming the crosslinked structure.

(3) Preferably, the second side chain further includes a second mesogenic moiety between the crosslinking moiety and the polymer backbone.

(4) Preferably, the liquid crystal polymer further includes a third side chain bound to the polymer backbone. The third side chain can include a chiral moiety.

(5) Preferably, in any one of items (1) to (3) above, the liquid crystal polymer particle is a monodisperse particle. Here, “monodisperse” means that the coefficient of variation obtained by dividing the standard deviation of a particle diameter distribution by the average particle diameter is not greater than 0.2, preferably, the coefficient of variation is not greater than 0.1, and more preferably, the coefficient of variation is not greater than 0.05. The coefficient of variation can be obtained from a result of measurement of the particle diameters of about 100 to 1000 liquid crystal polymer particles, for example. The particle diameter can be measured on an SEM image of an assembly body of the liquid crystal polymer particles.

(6) Preferably, in any one of items (1) to (4) above, the liquid crystal polymer particle is a cholesteric liquid crystal polymer particle.

(7) Preferably, the cholesteric liquid crystal polymer particle has a structure in which helical axes are radially oriented from a particle center. When the helical axes are radially oriented from the particle center, the cholesteric liquid crystal polymer particle can be a reflection material not dependent on the angle. Preferably, the cholesteric liquid crystal polymer particle does not include a core material that defines the orientation of the helical axes.

Preferably, in the cholesteric liquid crystal polymer particle, the helical axes are radially oriented due to orientation regulating force applied from the particle surface. In this case, even if the core material or the like is not included, radial orientation of the helical axes is obtained. Further, preferably, the cholesteric liquid crystal polymer particle is monodisperse. When the cholesteric liquid crystal polymer particle in which the helical axes are radially oriented is monodisperse, the particle can serve as a reflection material not dependent on the angle and exhibit vivid coloring. In addition, when the cholesteric liquid crystal polymer particle does not include the core material that defines the orientation of the helical axes, and has a structure in which the helical axes are radially oriented due to orientation regulating force applied from the particle surface, the cholesteric liquid crystal polymer particle can exhibit vivid coloring. That is, in a case where the orientation of the helical axes is regulated by a core material inside the particle, when a particle having failed in containing the core material is generated, a problem that the helical axes are not radially oriented occurs. When a particle in which the helical axes are not radially oriented is present in particles in which helical axes are radially oriented, vivid coloring is impaired. In contrast to this, when the helical axes are radially oriented due to orientation regulating force applied from the particle surface, a concern as to whether the core material is contained in the particle does not occur, and impairment of vivid coloring can be avoided.

(8) A liquid crystal polymer particle according to the embodiment can have a crosslinked structure in which a liquid crystal polymer represented by formula (1) below is crosslinked by a crosslinkable functional group below.

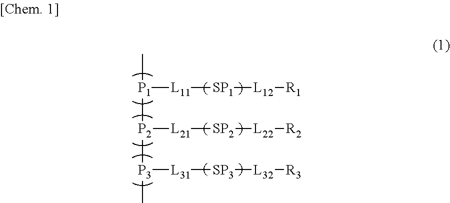

In formula (1),
P₁, P₂, and P₃ are each a repeating unit forming a polymer backbone generated through polymerization of any one selected from the group consisting of a vinyl group, an acrylic group, and a methacrylic group,
L₁₁, L₁₂, L₂₁, L₂₂, L₃₁, and L₃₂ are each independently a divalent linking group or a single bond,
SP₁, SP₂, and SP₃ are each a spacer group or a single bond,
R₁ is a mesogenic group,
R₂ is any one crosslinkable functional group selected from the group consisting of an oxetane group, an epoxy group, a vinyl ether group, and a derivative thereof, and
R₃ is a chiral group.

(9) A liquid crystal polymer particle according to the embodiment can have a crosslinked structure in which a liquid crystal polymer represented by formula (1) below is crosslinked by a crosslinkable functional group below.

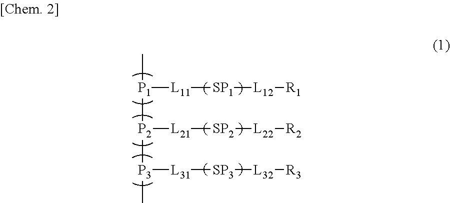

In formula (1),
P₁, P₂, and P₃ are each a repeating unit forming a polymer backbone,
L₁₁, L₁₂, L₂₁, L₂₂, L₃₁, and L₃₂ are each independently a divalent linking group or a single bond,
SP₁, SP₂, and SP₃ are each a spacer group or a single bond,
R₁ is a mesogenic group,
R₂ is a crosslinkable functional group having a reactivity different from that of the repeating unit, and
R₃ is a chiral group.

(10) A liquid crystal polymer particle according to the embodiment can have a crosslinked structure in which a liquid crystal polymer represented by formula (1) below is crosslinked by a crosslinkable functional group below.

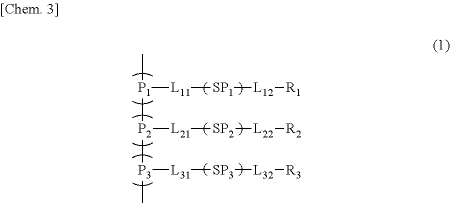

In formula (1),
P₁, P₂, and P₃ are each a repeating unit of a polymer backbone generated through polymerization of a radical polymerizable group,
L₁₁, L₁₂, L₂₁, L₂₂, L₃₁, and L₃₂ are each independently a divalent linking group or a single bond,
SP₁, SP₂, and SP₃ are each a spacer group or a single bond,
R₁ is a mesogenic group,
R₂ is a crosslinkable functional group for a ring-opening crosslinking reaction, and
R₃ is a chiral group.

(11) Preferably, in any one of items (8) to (10) above, the mesogenic group is any one selected from the group consisting of a phenyl group, a biphenyl group, a phenylcyclohexyl group, a bicyclohexyl group, a phenyl benzoate group, an azobenzene group, a tolane group, a derivative thereof, and a complex thereof.

(12) Preferably, in any one of items (8) to (10) above, the divalent linking group is any one selected from the group consisting of —O—, —C(═O)O—, —OC(═O)—, —C(═O)NH—, a divalent group of a mesogen, and a combination of two or more thereof. Preferably, the divalent group of the mesogen included in the divalent linking group is any one selected from the group consisting of a phenylene group, a biphenylene group, a divalent group of phenylcyclohexane, a bicyclohexylene group, a divalent group of phenyl benzoate, a divalent group of azobenzene, a divalent group of tolane, a derivative thereof, and a complex thereof.

(13) Preferably, in any one of items (8) to (10) above, the spacer group is any one selected from the group consisting of an alkylene group, an oxyalkylene group, a silylene group, and an oxysilylene group. More preferably, the spacer group is an alkylene group or an oxyalkylene group.

(14) A method for producing a liquid crystal polymer particle according to the embodiment includes: generating a non-crosslinked liquid crystal polymer particle through a polymerization reaction; and crosslinking, through a crosslinking reaction after the polymerization reaction, the non-crosslinked liquid crystal polymer particle generated through the polymerization reaction. The crosslinking reaction is a different-type-reactivity crosslinking reaction having a reactivity different from that of the polymerization reaction. Due to the two-step reaction composed of the polymerization reaction and the crosslinking reaction, variation in the shape and size or disturbance of the molecular orientation of the particle can be prevented. Preferably, with respect to the non-crosslinked liquid crystal polymer particle, in the course of dispersion polymerization for forming the non-crosslinked liquid crystal polymer particle, the helical axes are radially orientated from the particle center due to the dispersion stabilizer and the chiral agent.

(15) Preferably, the non-crosslinked liquid crystal polymer particle has a functional group that is not crosslinked in the polymerization reaction and that is crosslinked through the crosslinking reaction after the polymerization reaction.

(16) Preferably, the polymerization reaction is a polymerization reaction of: a liquid crystalline monomer including a first polymerizable group that is polymerized in the polymerization reaction; a polyfunctional crosslinking agent including a functional group that is not crosslinked in the polymerization reaction and a second polymerizable group that is polymerized in the polymerization reaction; and a chiral monomer including a third polymerizable group that is polymerized in the polymerization reaction.

(17) Preferably, the production method according to any one of items (14) to (16) above further includes introducing an initiator for the crosslinking reaction into the non-crosslinked liquid crystal polymer particle.

Preferably, the crosslinking reaction is a ring-opening crosslinking reaction. Preferably, the crosslinking reaction is a ring-opening crosslinking reaction of a cyclic ether as the functional group.

The functional group may be any one selected from the group consisting of an oxetane group, an epoxy group, a vinyl ether group, and a derivative thereof. The first polymerizable group, the second polymerizable group, and the third polymerizable group may be a radical polymerizable group. The first polymerizable group, the second polymerizable group, and the third polymerizable group may each be any one selected from the group consisting of a vinyl group, an acrylic group, a methacrylic group, and a derivative thereof.

Preferably, the polymerization reaction is a dispersion polymerization reaction. For example, the production method can include preparing a solution and performing dispersion polymerization in the solution. Preferably, in the solution, a liquid crystalline monomer, a crosslinking agent, a chiral agent, a dispersion stabilizer, and a polymerization initiator are dissolved in a solvent. Preferably, the liquid crystalline monomer, the crosslinking agent, the chiral agent, the dispersion stabilizer, and the polymerization initiator are all dissolved in the solvent, and the solution before polymerization does not include droplets. In the embodiment, preferably, the solution does not include a core material that defines the orientation of liquid crystals. In the embodiment, in the course of the dispersion polymerization, cholesteric liquid crystal polymer particles which are monodisperse and in each of which helical axes are radially oriented from the particle center can be formed. In the course of the dispersion polymerization, the dispersion stabilizer and the chiral agent radially orient the helical axes from the particle center. An orientation structure in which the helical axes are radially oriented from the particle center due to the dispersion stabilizer and the chiral agent can be obtained in the course of the dispersion polymerization. Since the dispersion stabilizer and the chiral agent define the orientation, the solution before polymerization need not include a substance to serve as a core material that defines the orientation of liquid crystals.

The chiral agent can induce a helical structure, but cannot control the direction of the helical axis direction. Therefore, in order to radially orient the helical axes, a substance that causes such orientation regulating force is necessary. In a particle, in order to cause the helical axis direction to be radial, providing a core material present in the center of the particle is conceivable. The core material can define the liquid crystal molecular orientation from the center of the particle, and thus can regulate the helical axis direction so as to be radial. However, in order to form a particle having the core material, it is necessary to disperse an undissolved core material in a solution in advance, which decreases ease of production. In addition, even when the core material is dispersed in the solution, there is no guarantee that a particle is formed with the core material as the center, and a particle in which the core material is not present therein may be formed. If there is no core material in the particle, radial orientation cannot be obtained. As a result, in a particle assembly body that is produced, particles in a radial state and particles not in the radial state are both present, which may impair vivid coloring.

In contrast to this, in a case where the dispersion stabilizer defines the orientation together with the chiral agent, even if the core material is absent, the helical axes can be radially oriented. Therefore, radially arrayed helical axes can be obtained without need of a core material, and formation of particles not including the core material need not be a cause for concern.

In the course of the dispersion polymerization, the dispersion stabilizer stabilizes dispersion of polymer particles deposited in the solvent and causes anchoring force for orienting liquid crystal molecules so as to be parallel to the surface of each polymer particle to act. As a result of the liquid crystal molecules being orientated in parallel to the surface of the polymer particle, a helically orientated structure in which the helical axes are oriented in the particle radial direction (radial direction) under influence of the chiral agent, is obtained.

(18) Preferably, in any one of items (14) to (17) above, the crosslinking reaction is a reaction in which an acid or an acid generator is used as an initiator for the crosslinking reaction.

(19) Preferably, in any one of items (14) to (18) above, the non-crosslinked liquid crystal polymer particle is a cholesteric liquid crystal polymer particle.

(20) Preferably, in any one of items (14) to (19) above, the non-crosslinked liquid crystal polymer particle is a cholesteric liquid crystal polymer particle in which helical axes are radially oriented from a particle center.

### <2. Example of Liquid Crystal Polymer Particle and a Method for Producing Liquid Crystal Polymer Particle>

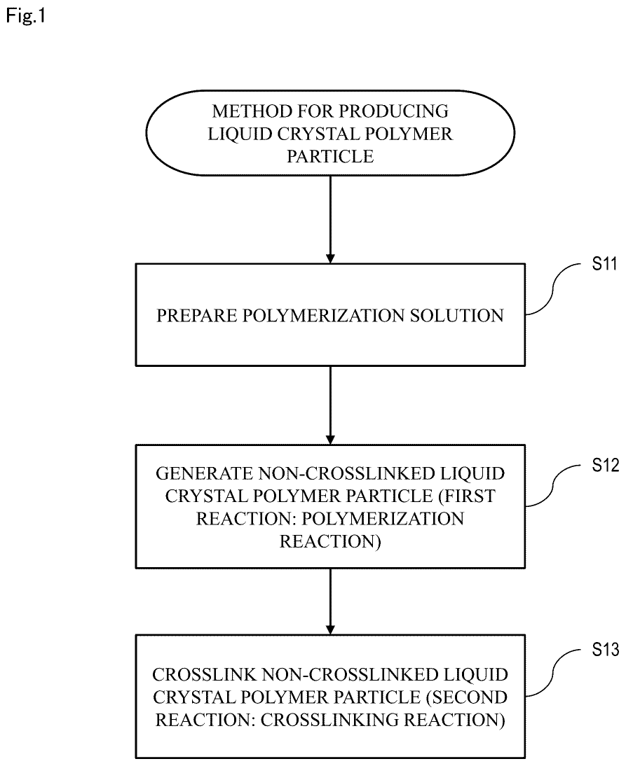

Hereinafter, with reference to the drawings, examples of the liquid crystal polymer particle and a method for producing the liquid crystal polymer particle will be described in further detail. However, the present invention is not limited to these examples. FIG. 1 shows an example of a method for producing the liquid crystal polymer particle. The production method according to an embodiment includes: a preparation step (step S11) of a polymerization solution; a step (step S12) of generating a non-crosslinked liquid crystal polymer particle through a polymerization reaction of the polymerization solution; and a step (step S13) of crosslinking the non-crosslinked liquid crystal polymer particle through a crosslinking reaction. When the non-crosslinked liquid crystal polymer particle is crosslinked, polymers in the non-crosslinked liquid crystal polymer particle are crosslinked. Accordingly, a crosslinked liquid crystal polymer particle is obtained.

In the following, an example in which the liquid crystal polymer particle obtained by the production method according to the embodiment is a cholesteric liquid crystal polymer particle will be described. A cholesteric liquid crystal is a matter in which liquid crystal molecules having refractive index anisotropy are helically oriented, and exhibits a vivid structural color by selectively reflecting light having a specific wavelength in accordance with a helical pitch. The liquid crystal polymer particle that is obtained is not limited to the cholesteric liquid crystal polymer particle. In the following, a case where, in the cholesteric liquid crystal polymer particle that is obtained, the helical axes are radially oriented from the particle center, and the cholesteric liquid crystal polymer particle is monodisperse, will be described. Here, when the helical axis is oriented in one axis direction, reflection color from the particle changes dependently on the angle of visibility. However, if the orientation of the helical axis is three-dimensionally controlled such that the helical axes are radially oriented, reflection color not dependent on the angle of visibility can be generated. The cholesteric liquid crystal polymer particle that is obtained is not limited to one in which the helical axes are radially oriented from the particle center. The particle that is obtained need not necessarily be monodisperse.

Polymerization in step S12 is dispersion polymerization, as an example. The dispersion polymerization is advantageous to obtain a cholesteric liquid crystal polymer particle in which the helical axes are radially oriented from the particle center, and which is monodisperse. In the polymerization reaction in step S12, a polymer chain in which a first polymerizable group, and a second polymerizable group and a third polymerizable group described later are polymerized is formed, for example. In the polymerization reaction in step S12, a liquid crystal polymer particle composed of liquid crystal polymers is formed. When the polymerization reaction is a dispersion polymerization reaction, liquid crystal polymers generated through the dispersion polymerization reaction are deposited as particles in the solution.

A crosslinking reaction in step S13 crosslinks liquid crystal polymers formed in step S12. For example, in the crosslinking reaction in step S13, chain-like liquid crystal polymers (polymer chains) forming the liquid crystal polymer particle and generated in the polymerization reaction in step S12 are crosslinked through the crosslinking reaction. Through the crosslinking, external stimulation responsiveness of the particle is adjusted. In addition, through the crosslinking, external environment stability can be provided to the particle. The crosslinking reaction in step S13 is a different-type-reactivity crosslinking reaction having a reactivity different from that of the polymerization reaction in step S12. Here, the different-type-reactivity crosslinking reaction is a crosslinking reaction in which a functional group different from the functional group involved in the polymerization reaction is involved.

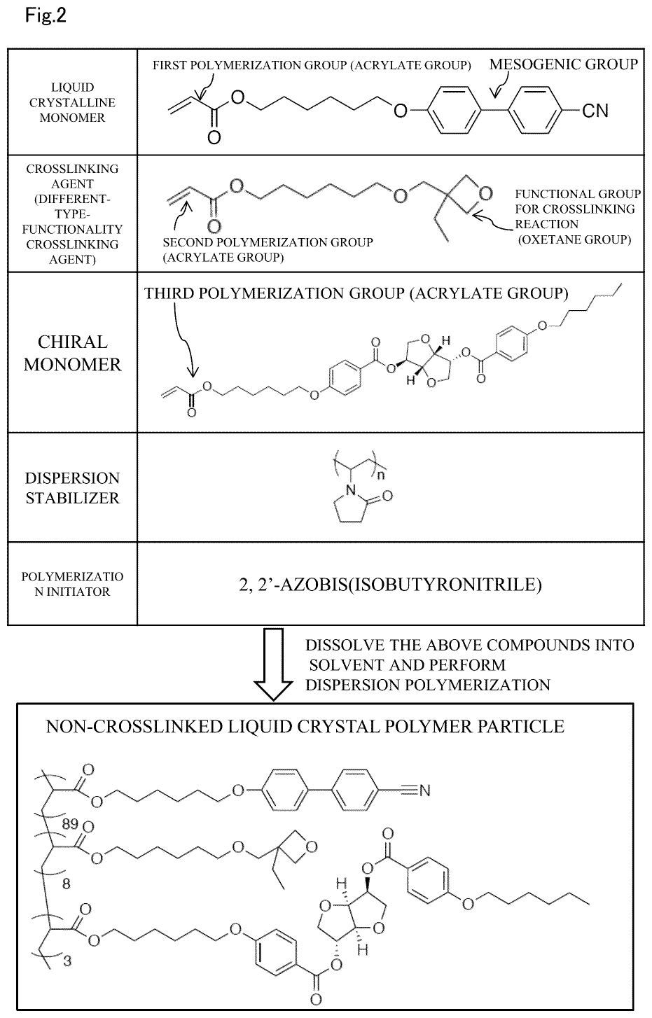

Raw materials of the polymerization solution are a liquid crystalline monomer, a crosslinking agent (crosslinking monomer), a chiral agent (chiral monomer), a dispersion stabilizer, and a polymerization initiator, as shown in FIG. 2 as an example. A mixture of these raw materials is dissolved in a solvent. The choice of the solvent and the dispersion stabilizer influences the particle diameter, monodispersity, and molecular orientation property of the liquid crystal polymer particle.

The liquid crystal monomer includes a mesogenic moiety. The liquid crystalline monomer shown in FIG. 2 is a compound that includes: a mesogenic group being a functional group for expressing a liquid crystal property; and a polymerizable group being a functional group for the polymerization reaction in step S12. The polymerizable group of the liquid crystalline monomer is referred to as a first polymerizable group. As the liquid crystalline monomer, the compound shown in FIG. 2 is used, for example. The liquid crystalline monomer is not limited to the structure shown as an example in FIG. 2, and a liquid crystalline monomer having another structure can be used. The liquid crystal monomer according to the embodiment has only one polymerizable group, but in terms of particle stability, may have a plurality of polymerizable groups.

Preferably, the mesogenic group is any one selected from the group consisting of a phenyl group, a biphenyl group, a phenylcyclohexyl group, a bicyclohexyl group, a phenyl benzoate group, an azobenzene group, a tolane group, a hetero element derivative thereof, and a complex thereof, for example. The first polymerizable group is any one selected from the group consisting of a vinyl group, an acrylic group, and a methacrylic group, for example. The vinyl group is an acrylate group, for example. In the polymerization reaction in step S12, a polymer chain in which the first polymerizable group, and the second polymerizable group and the third polymerizable group described later are polymerized is formed, for example.

The crosslinking agent is a compound having a functional group for the crosslinking reaction in step S13. The crosslinking agent according to the embodiment is a polyfunctional crosslinking agent. “Polyfunctional” means that a compound includes a plurality of functional groups. The crosslinking agent according to the embodiment is a different-type-functionality crosslinking agent in which the types of the plurality of functional groups are different. More specifically, the “different-type-functionality” here means having a functional group (crosslinkable functional group) different from the polymerizable group for the polymerization reaction in step S12. The crosslinking agent according to the embodiment can also be said to be a different-type-polymerization crosslinking agent. The “different-type-polymerization” here has the same meaning as the “different-type-functionality”. The functional group that the crosslinking agent according to the embodiment has for the crosslinking reaction is not involved in the polymerization reaction in step S12 and is involved in the crosslinking reaction in step S13, to form a crosslinked structure. The crosslinking agent may include a mesogenic moiety.

If the functional group (crosslinkable functional group) for the crosslinking reaction is a functional group of the same type as that of the second polymerizable group, the crosslinking reaction is caused in the polymerization reaction in step S12. However, with respect to the functional group for the crosslinking reaction, since the functional group for the crosslinking reaction in step S13 is a functional group of a type different from that of the second polymerizable group, the crosslinking reaction can be prevented from occurring at the functional group for the crosslinking reaction in step S12. Therefore, during formation of particles in step S12, the crosslinking reaction does not occur. The present inventors experimentally found the following: when the crosslinking reaction occurs simultaneously with the formation of particles, aggregation of the particles is promoted by the crosslinking reaction, whereby the particle size may be increased, and/or disturbance of the liquid crystal molecular orientation may occur in association with the crosslinking. However, when crosslinking is caused after formation of the liquid crystal polymer particles, increase in the particle size and disturbance of the liquid crystal molecular orientation can be prevented. The crosslinking agent may include a plurality of functional groups for the crosslinking reaction.

Preferably, the functional group for the crosslinking reaction in step S13 is a cyclic ether. Preferably, the cyclic ether is an oxetane group, an epoxy group, or a derivative thereof, for example. The functional group for the crosslinking reaction in step S13 is not limited to a cyclic ether, and may be a vinyl group (vinyl ether group, styrene derivative) having an electron-donating group. The crosslinking agent shown in FIG. 2 includes an oxetane group as the functional group for the crosslinking reaction. The oxetane group is a cyclic ether having a structure that includes one oxygen in a saturated four membered-ring.

As shown in FIG. 2, the crosslinking agent according to the embodiment includes a polymerizable group for the polymerization reaction in step S12, in addition to the functional group for the crosslinking reaction in step S13. The polymerizable group of the crosslinking agent is referred to as the second polymerizable group. The second polymerizable group is involved in the polymerization reaction in step S12, and forms a part of a liquid crystal polymer composed of a polymer chain, for example.

The second polymerizable group is any of a vinyl group, an acrylic group, and a methacrylic group, for example. The vinyl group is an acrylate group, for example. Preferably, the second polymerizable group is a functional group of the same type as that of the first polymerizable group.

As the crosslinking agent, a compound having the structure shown in FIG. 2 is used, for example. Not limited to the structure shown as an example in FIG. 2, the crosslinking agent may have another structure. The crosslinking agent shown in FIG. 2 is a bifunctional crosslinking agent including one polymerizable group for the polymerization reaction and one functional group for the crosslinking reaction.

The chiral agent (chiral monomer) is a compound that induces a helical structure of a liquid crystal. The chiral agent (chiral monomer) according to the embodiment is a derivative (polymerizable chiral agent) obtained by introducing a polymerizable group for the polymerization reaction in step S12 into a general-purpose chiral agent. The polymerizable group of the chiral agent (chiral monomer) is referred to as the third polymerizable group. The third polymerizable group is involved in the polymerization reaction in step S12, and forms a part of a liquid crystal polymer composed of a polymer chain, for example.

The third polymerizable group is any of a vinyl group, an acrylic group, and a methacrylic group, for example. The vinyl group is an acrylate group, for example. Preferably, the third polymerizable group is a functional group of the same type as that of the first polymerizable group and the second polymerizable group.

As the chiral agent (chiral monomer), a compound having the structure shown in FIG. 2 is used, for example. The chiral agent need not necessarily have the structure having an isosorbide skeleton shown as an example in FIG. 2, and may be a polymerizable chiral agent having another structure. Specifically, the chiral agent only needs to have an “asymmetric center”, an “asymmetric axis”, an “asymmetric plane”, or a “helical axis” in the molecular skeleton, and further, have the third polymerizable group in the same molecule.

For example, the chiral agent according to the embodiment may be a derivative in which the third polymerizable group is introduced in “S-811” or “R-811”, which is a chiral agent most generally used. The compound having an asymmetric center is isosorbide, cholesterol, or S811, for example. The compound having an asymmetric axis is allene, biphenyl, or BINAP, for example. The compound having an asymmetric plane is cyclophane, for example. The compound having a helical axis is helicene, for example.

Here, the period of the helical structure of the cholesteric liquid crystal is determined by a “helical twisting power (HTP)” due to the molecular structure of the chiral agent. A chiral agent having a higher HTP (HTP>several ten μm⁻¹) is more preferable since a very small addition amount (not greater than several mol %) thereof enables control of the reflection band from an ultraviolet region to a visible light region. The amount of the chiral agent used in the embodiment may be an amount of several mol % with respect to the liquid crystalline monomer, and, for example, may be an amount of 4 mol % with respect to the liquid crystalline monomer.

In the course of polymerization, the dispersion stabilizer suppresses aggregation of the liquid crystal polymer particles deposited from the solution, and stabilizes the dispersed state of liquid crystal polymers. As the dispersion stabilizer, polyvinyl pyrrolidone shown in FIG. 2 is used, for example. Accordingly, a graft polymer is caused through a chain transfer reaction, whereby particles can be obtained. In addition to the dispersion stabilizer shown in FIG. 2, the dispersion stabilizer may be such a hydrophilic polymer that causes a chain transfer reaction, and the polymerization degree thereof is more preferably 100 to 1000. The dispersion stabilizer may be one that becomes a graft polymer through a copolymerization reaction, to obtain particles, and may be a polymer compound having a polymerizable group and a hydrophilic group, for example. The dispersion stabilizer is added in an amount of 40 wt % when the weight of the monomer is defined as 100, for example.

The dispersion stabilizer may be a high molecular weight substance having a high solubility in a solvent that is used. When a non-polymerizable high molecular weight substance is used as the dispersion stabilizer, one having a high graft reactivity is preferably used as the dispersion stabilizer since the dispersion stabilizer needs to be grafted through chain transfer from the monomer polymerization system. As the dispersion stabilizer, a polymerizable high molecular weight substance (macromonomer) can also be used. In this case, a copolymer with a mainly used monomer is formed, such that the macromonomer is presented in a shell-like manner on the particle surface. That is, any polymer material that is soluble in a solvent can be used as the dispersion stabilizer.

The polymerization initiator may be a thermal polymerization initiator or may be a photopolymerization initiator. In FIG. 2, as the thermal polymerization initiator, 2,2′-azobis(isobutyronitrile) is used.

A polymerization raw material mixture composed of the liquid crystalline monomer, the crosslinking agent, the chiral agent, the dispersion stabilizer, and the polymerization initiator as described above is dissolved in a solvent to prepare a solution, and this solution is used as a polymerization solution (polymerization sample) (step S11). After the preparation of the polymerization solution, dispersion polymerization is performed in the polymerization solution (step S12). The polymerization may be thermal polymerization or may be photopolymerization. In the embodiment, as an example, in the course of this dispersion polymerization, the cholesteric liquid crystal polymer particle which is monodisperse and in which helical axes are radially oriented from the particle center is formed. In the course of this dispersion polymerization, the functional group for the crosslinking reaction is not involved in the reaction. Therefore, the particle that is formed is the non-crosslinked liquid crystal polymer particle although including the crosslinking agent.

The solvent is a good solvent for the liquid crystalline monomer, the crosslinking agent, the chiral agent, the dispersion stabilizer, and the polymerization initiator, which are the polymerization raw materials. Since the solvent is a good solvent for the polymerization raw materials, a homogeneous solution is obtained. Further, the solvent is a poor solvent for the polymer to be generated through polymerization. Therefore, the monomer uniformly dissolved in the solvent forms a polymer (primary particle) through polymerization, and then becomes insoluble in the solvent to be deposited. The deposited polymer (primary particle) serves as a particle nucleus, whereby the primary particle grows and a particle shape is formed. As a result, a liquid crystal polymer particle is obtained.

Through adjustment of the solubility of the polymer, the particle diameter (average particle diameter) of a group of the liquid crystal polymer particles being monodisperse can be adjusted. In general, the solubility of a polymer is adjusted by mixing two types of solvents (good solvent and poor solvent). Therefore, according to the mixing ratio of the two types of solvents, the particle diameter of the group of the liquid crystal polymer particles being monodisperse can be adjusted. The particle diameter can be adjusted in a range of several hundred nm to several ten μm, for example. The particle diameter (diameter) of the cholesteric liquid crystal polymer particle obtained by the production method according to the embodiment is in a range of 0.2 μm to 100 μm and preferably in a range of 1 μm to 50 μm.

The solvent in which the polymerization raw materials are dissolved is a mixture of a poor solvent for the polymer to be generated and a good solvent for the polymer to be generated, for example. The poor solvent for the polymer to be generated may be methanol (MeOH), as an example, and the good solvent for the polymer to be generated may be N,N-dimethylformamide (DMF), as an example.

The dispersion stabilizer is grafted on the surface of the deposited polymer in the course of the dispersion polymerization. The dispersion stabilizer also functions, together with the chiral agent, as an orientation control agent that radially orient the helical axes of the liquid crystal. The molecular orientation direction inside the particle is defined dependently on the surface energy of the dispersion stabilizer that is used. Therefore, in the embodiment, a uniform molecular orientation structure can be spontaneously (without need of a core material) formed in the course of the polymerization.

Here, the direction of the helical axis in a particle is determined by the regulating force on liquid crystals at the particle interface. That is, the orientation state of the liquid crystals is determined by interaction with the interface (surface), and thus, can be determined by taking into consideration the torque balance at the surface and in the bulk based on interface free energy (interface tension).

In the embodiment, the dispersion stabilizer grafted on the particle surface has anchoring force that causes the molecular orientation to be parallel to the particle surface. Therefore, liquid crystal molecules are oriented in parallel to the surface due to the dispersion stabilizer, and as a result of this, a helically orientated structure is formed in the radial direction under the influence of the chiral agent. As a result of these, the helical axes are oriented in the radial direction (radially). That is, in the cholesteric liquid crystal polymer particle according to the embodiment, the helical axes are radially oriented under the molecular orientation regulating force from the particle surface.

In the embodiment, the helical axes are radially orientated without need of a core material. Therefore, an angle-dependent particle in which the helical axes are not radially oriented due to the absence of the core material therein is less likely to be formed. Therefore, in an assembly of the cholesteric liquid crystal polymer particles that are formed, almost all of the cholesteric liquid crystal polymer particles are particles (specific particles) in each of which the helical axes are radially orientated. In an assembly body composed of a large number of the cholesteric liquid crystal polymer particles, the proportion of the specific particles is preferably not less than 95%, more preferably not less than 98%, and further preferably not less than 99%. When the proportion of the specific particles is larger, more vivid coloring is obtained. The cholesteric liquid crystal polymer particles that are monodisperse exhibit vivid coloring as compared with those that are not monodisperse.

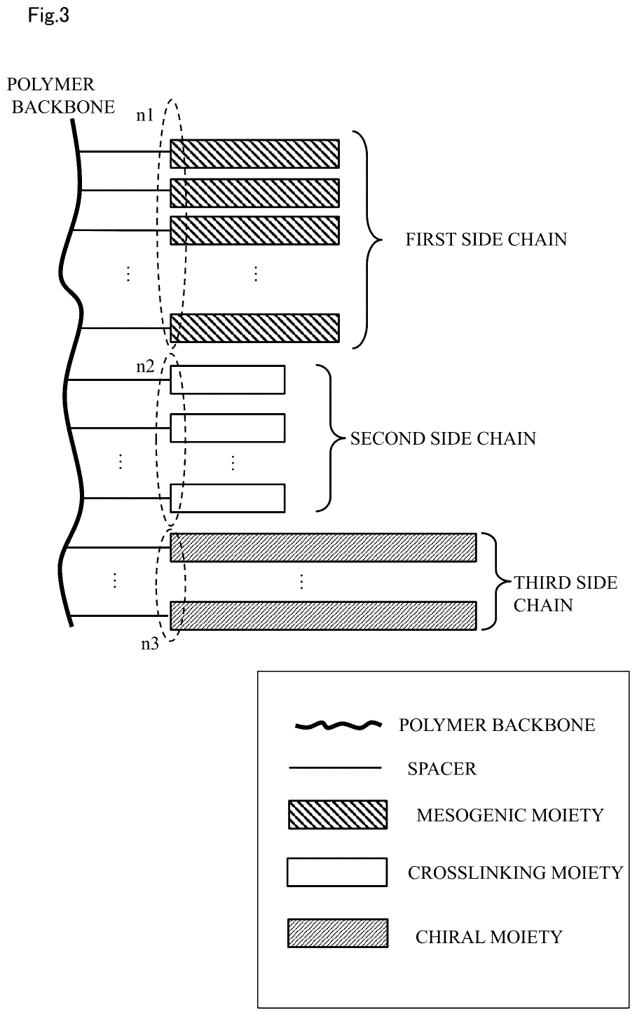

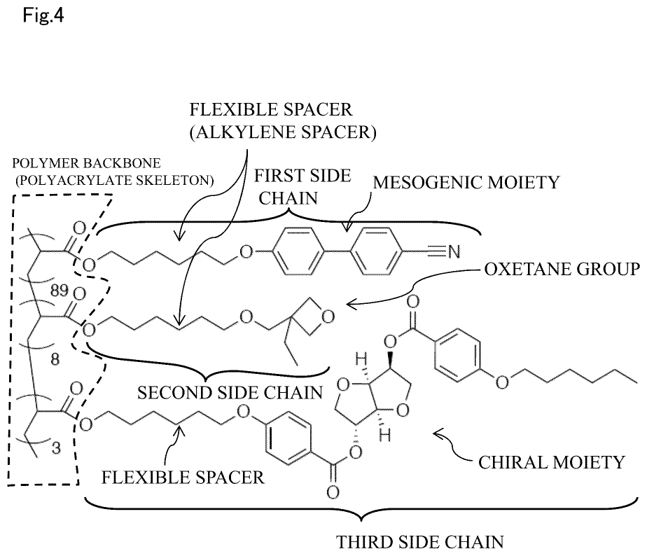

FIG. 3 and FIG. 4 show an example of a chemical structure of a liquid crystal polymer forming the liquid crystal polymer particle obtained through the polymerization reaction in step S12. This liquid crystal polymer is composed of a copolymer of: the liquid crystalline monomer including the first polymerizable group that is polymerized in the polymerization reaction in step S12; the polyfunctional crosslinking agent including the functional group (crosslinkable functional group) that is not crosslinked in the polymerization reaction in step S12 and the second polymerizable group that is polymerized in the polymerization reaction in step S12; and the chiral monomer including the third polymerizable group that is polymerized in the polymerization reaction in step S12.

As shown in FIG. 3, this liquid crystal polymer is a side-chain-type liquid crystal polymer in which side chains are bound to a polymer backbone. A first side chain including a mesogenic moiety and a second side chain including a crosslinking moiety are bound to the polymer backbone shown in FIG. 3. Further, a third side chain including a chiral moiety is bound to the polymer backbone shown in FIG. 3. The structure shown in FIG. 3 is also represented by formula (2) shown below. Formula (2) below is obtained by adding the numbers of repetition n₁, n₂, and n₃ of P₁, P₂, and P₃ and the numbers of repetition m1, m2, and m3 of SP₁, SP₂, and S_{P3} to formula (1) described above.

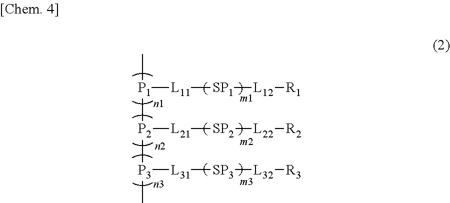

In Formula (2), P₁, P₂, and P₃ are each a repeating unit forming the polymer backbone, and the first side chain, the second side chain, and the third side chain are bound to the polymer backbone. The first side chain includes R₁ bound to the polymer backbone via a spacer SP₁. Linking groups L₁₁ and L₁₂ are provided at both ends of the spacer SP₁. The linking groups L₁₁ and L₁₂ and the spacer SP₁ are collectively referred to as a “first spacer moiety”. Therefore, the first side chain can also be said to include R₁ bound to the polymer backbone via the first spacer moiety. The second side chain includes R₂ bound to the polymer backbone via a spacer SP₂. Linking groups L₂₁ and L₂₂ are provided at both ends of the spacer SP₂. The linking groups L₂₁ and L₂₂ and the spacer SP₂ are collectively referred to as a “second spacer moiety”. Therefore, the second side chain can also be said to include R₂ bound to the polymer backbone via the second spacer moiety. The third side chain includes R₃ bound to the polymer backbone via a spacer SP₃. Linking groups L₃₁ and L₃₂ are provided at both ends of the spacer SP₃. The linking groups L₃₁ and L₃₂ and the spacer SP₃ are collectively referred to as a “third spacer moiety”. Therefore, the third side chain can also be said to include R₃ bound to the polymer backbone via the third spacer moiety. Regarding formula (2), configurations not described in particular are the same as those in formula (1).

The polymer backbone is formed by the first polymerizable group, the second polymerizable group, and the third polymerizable group being bound in a chain-like manner through polymerization. The polymer backbone is formed as a polyacrylate skeleton, for example.

The first side chain shown in FIG. 3 is a moiety corresponding to the liquid crystal monomer. The first side chain includes a spacer and a mesogenic moiety, as an example. The first side chain can include the first spacer moiety and a first mesogenic moiety. The spacer or the spacer moiety may be omitted. The mesogenic moiety is bound to the polymer backbone via the spacer or the first spacer moiety. The mesogenic moiety is a moiety having the mesogenic group R₁ in formulae (1) and (2), and is a moiety corresponding to the mesogenic group in the liquid crystal monomer. The mesogenic moiety is also referred to as a liquid crystal moiety. The spacer is a flexible spacer, for example. The spacer includes a hydrocarbon chain, for example. The hydrocarbon chain is an alkylene chain, for example. When the spacer is present, the chain length (the number of repetition of SP₁) m1 of the spacer (alkylene chain) is, for example, 1 to 16, more preferably 4 to 10, and further preferably 4 to 8. In other words, m1 is preferably not less than 1 and more preferably not less than 4. m1 is preferably not greater than 16, more preferably not greater than 10, and further preferably not greater than 8. In FIG. 2 and FIG. 4, the chain length m1 of the spacer (alkylene chain) is 6.

In FIG. 3 and formula (2), n1 represents the number of the first side chains when the first side chain is a repeating unit. n1 is, for example, 30 to 300 and more preferably 60 to 200. In other words, n1 is preferably not less than 30 and more preferably not less than 60. n1 is preferably not greater than 300 and more preferably not greater than 200. In FIG. 2 and FIG. 4, n1 is 89, as an example.

The second side chain shown in FIG. 3 is a moiety corresponding to the crosslinking agent. The second side chain includes a spacer and a crosslinking moiety, as an example. The second side chain can include the second spacer moiety and a crosslinking moiety. The spacer or the spacer moiety may be omitted. The second side chain may include a second mesogenic moiety and a crosslinking moiety. The crosslinking moiety here is a moiety including a functional group (e.g., oxetane group) for the crosslinking reaction, and is a moiety including the crosslinkable functional group R₂ in formulae (1) and (2). The crosslinking moiety is crosslinked with another liquid crystal polymer through the crosslinking reaction, to form a crosslinked structure. The crosslinking moiety is bound to the polymer backbone via the spacer or the second spacer moiety. The second spacer moiety may include the second mesogenic moiety. The second mesogenic moiety can be included in the linking group of the second spacer moiety. The second mesogenic moiety can be provided between the crosslinking moiety and the polymer backbone. Details of the spacer and the spacer moiety in the second side chain may be the same as or different from those of the spacer or the spacer moiety in the first side chain. The molecular structure of the spacer or the spacer moiety in the second side chain may be the same as that of the spacer or the spacer moiety in the first side chain, or may be determined independently of the spacer or the spacer moiety in the first side chain. When the spacer is present in the second side chain, the chain length (the number of repetition of SP₂) m2 of the spacer (alkylene chain) is, for example, 1 to 16, more preferably 4 to 10, and further preferably 4 to 8. In other words, m2 is preferably not less than 1 and more preferably not less than 4. m2 is preferably not greater than 16, more preferably not greater than 10, and further preferably not greater than 8. In FIG. 2 and FIG. 4, the chain length m2 of the spacer (alkylene chain) is 6.

In FIG. 3, n2 represents the number of the second side chains when the second side chain is a repeating unit. n2 is, for example, 1 to 60 and more preferably 2 to 20. In other words, in FIG. 2 and FIG. 4, n2 is preferably not less than 1 and more preferably not less than 2. n2 is preferably not greater than 60 and more preferably not greater than 20. As an example, n2 is 8. n2 is determined in accordance with the concentration of the crosslinking agent. n2 is, for example, a value of 0.5% to 20% of n1 and more preferably a value of 3% to 10% of n1.

The third side chain shown in FIG. 3 is a moiety corresponding to the chiral agent (the chiral monomer). The third side chain includes a spacer and a chiral moiety, as an example. The third side chain can include the third spacer moiety and a chiral moiety. The spacer or the third spacer moiety may be omitted. The chiral moiety is bound to the polymer backbone via the spacer or the third spacer moiety. The chiral moiety is a moiety that includes a molecule forming an “asymmetric center”, an “asymmetric axis”, an “asymmetric plane”, or a “helical axis” in the molecular skeleton, and is a moiety including the chiral group R₃ in formulae (1) and (2). The chiral moiety orients the mesogenic moiety (liquid crystal moiety). Details of the spacer or the third spacer moiety in the third side chain may be the same as or different from those of the spacer or the spacer moiety in the first side chain or the second side chain. The molecular structure of the third side chain may be the same as that of the spacer or the spacer moiety in the first side chain or the second side chain, or may be determined independently of the spacer or the spacer moiety in the first side chain or the second side chain. When the spacer is present in the third side chain, the chain length (the number of repetition of SP₃) m3 of the spacer (alkylene chain) is, for example, 1 to 16, more preferably 4 to 10, and further preferably 4 to 8. In other words, m3 is preferably not less than 1 and more preferably not less than 4. m3 is preferably not greater than 16 and more preferably not greater than 10. In FIG. 2 and FIG. 4, the chain length m3 of the spacer (alkylene chain) is 6.

In FIG. 3, n3 represents the number of the third side chains when the third side chain is a repeating unit. n3 can be determined as desired, dependently on the helix induction force, for example. The value of n3 is determined in accordance with the concentration of the chiral agent. In FIG. 2 and FIG. 4, n3 is 3, as an example.

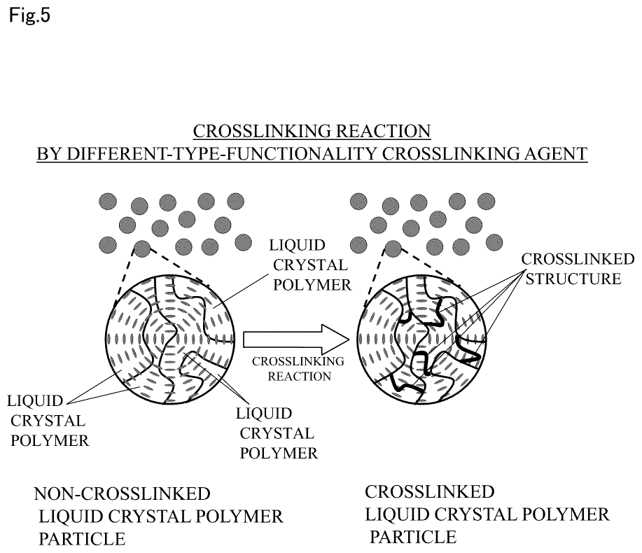

With reference back to FIG. 1, in step S13, the particles are subjected to the crosslinking reaction. Due to the crosslinking reaction, liquid crystal polymers are crosslinked in the inside of each particle. That is, in step S13, as shown in FIG. 5, a crosslinked liquid crystal polymer particle is obtained from a non-crosslinked liquid crystal polymer particle. As shown in FIG. 5, in a non-crosslinked state, a liquid crystal polymer particle is an assembly body of a plurality of liquid crystal polymers, and, as an example, has a monodomain liquid crystal structure in which helical axes are radially oriented. This monodomain liquid crystal structure is not crosslinked before the crosslinking reaction in step S13. When the liquid crystal polymers forming the liquid crystal polymer particle are crosslinked through the crosslinking reaction that occurs in the crosslinking moiety described above, a crosslinked structure is obtained. That is, through the crosslinking reaction, the liquid crystal polymer particle becomes a crosslinked body.

In the embodiment, in a non-crosslinked state, a monodomain in which liquid crystal molecules have a predetermined orientation property is formed in the particle. In addition, the group of the particles is uniform in particle diameter in a non-crosslinked state, and is monodisperse. Thus, the liquid crystal polymer particle according to the embodiment has a preferable property of having a monodomain liquid crystal structure in a non-crosslinked state and being monodisperse. The crosslinking reaction of the embodiment is performed as a post-step of the polymerization reaction for forming the particle. Since the particle synthesized through the polymerization reaction is crosslinked afterwards, external stimulation responsiveness can be adjusted or external environment stability can be provided while the above-described preferable property is maintained. For example, when a desired elasticity is provided to the particle through the crosslinking, a liquid crystal elastomer particle is obtained. Further, heat resistance or chemical resistance can also be provided to the particle through the crosslinking.

The crosslinking reaction in step S13 only crosslinks the already formed liquid crystal polymers, and thus, influence on the size and the liquid crystal molecular orientation of the liquid crystal polymer particle is small. Therefore, the preferable property (i.e., having a monodomain liquid crystal structure in which the liquid crystal orientation is uniform, and being monodisperse) of the non-crosslinked liquid crystal polymer particle is also maintained in the crosslinked liquid crystal polymer particle.

The crosslinking reaction in step S13 is a cationic polymerization reaction (cation crosslinking reaction), for example. The crosslinking reaction is preferably a crosslinking reaction that utilizes ring-opening of a cyclic functional group (cyclic ether). The cyclic ether is an oxetane group, for example. In the crosslinking reaction utilizing the ring-opening, a ring-opening reaction of the cyclic ether and an addition reaction occur. The crosslinking reaction in step S13 is not limited in particular as long as the crosslinking reaction is a reaction that does not occur during the polymerization reaction in step S12 and that can crosslink liquid crystal polymers afterwards. For example, the crosslinking reaction in step S13 may be a chemical reaction such as photodimerization, hydrosilylation, or esterification.

In order to initiate the crosslinking reaction, a crosslinking reaction initiator is used. As an example, in a case of a cationic polymerization crosslinking reaction based on an acid, an acid or an acid generator is used as the crosslinking reaction initiator. The stronger the acid is, the higher the polymerization activity (crosslinking activity) of the cationic polymerization becomes. The crosslinking reaction need not necessarily be initiated by the acid.

The acid as the crosslinking reaction initiator may be either of Bronsted acid and Lewis acid, for example. Bronsted acid is an acid according to the definition by Bronsted, and is a donor of a proton (H⁺). Bronsted acid is any one of perchloric acid, sulfuric acid, and hydrochloric acid, for example. Lewis acid is an acid according to the definition by Lewis, and is a substance that receives an electron pair. Lewis acid is BF₃, TiCl₄, or aluminum chloride, for example.

The acid generator as the crosslinking reaction initiator is a photoacid generator or a thermal acid generator, for example. The photoacid generator is a compound (photosensitizer) that generates an acid by absorbing applied light (e.g., ultraviolet light). In general, the photoacid generator is used as a photo cationic polymerization initiator. The photoacid generator may be either sulfonium-salt-based or iodonium-salt-based, for example. The thermal acid generator is a compound that generates an acid due to heat. In general, the thermal acid generator is used as a thermal cationic polymerization initiator.

The crosslinking reaction initiator is introduced into the non-crosslinked liquid crystal polymer particle through diffusion, for example. For example, when the non-crosslinked liquid crystal polymer particles are dispersed in a solution containing the crosslinking reaction initiator, the initiator in the solution is introduced into the non-crosslinked liquid crystal polymer particles through diffusion.

The solution containing the crosslinking reaction initiator may be a solution of an acid as the crosslinking reaction initiator. The solution of an acid as the crosslinking reaction initiator is a solution of perchloric acid, a solution of sulfuric acid, a solution of hydrochloric acid, a solution of BF₃, or a solution of TiCl₄, for example. When the non-crosslinked liquid crystal polymer particles are dispersed in the solution of an acid as the crosslinking reaction initiator, the acid is introduced into the particles through diffusion, and the crosslinking reaction inside each particle is initiated and advanced in the solution, whereby liquid crystal polymers inside the particle can be crosslinked. Accordingly, crosslinked liquid crystal polymer particles are obtained. In order to promote the diffusion and the crosslinking reaction, the solution is preferably stirred during the acid diffusion and the crosslinking reaction.

The solution containing the initiator for the crosslinking reaction may be one obtained by dissolving the acid generator in a solvent. In order to suppress dissolution of the non-crosslinked liquid crystal polymer particles, the solvent is preferably a poor solvent for the non-crosslinked liquid crystal polymer particle. The poor solvent is methanol (MeOH), for example. Methanol is suitable since the non-crosslinked liquid crystal polymer particles can be dispersed, with the liquid crystal phase maintained. When the non-crosslinked liquid crystal polymer particles are dispersed in the solution in which the acid generator is dissolved, the acid generator is introduced into the non-crosslinked liquid crystal polymer particles through diffusion. In order to promote the diffusion, the solution is preferably stirred.

When light or heat that generates an acid is applied to the non-crosslinked liquid crystal polymer particle into which the acid generator has been introduced, the acid is generated in the non-crosslinked liquid crystal polymer particle. Due to the acid, the cationic polymerization crosslinking reaction occurs in the particle, whereby liquid crystal polymers inside the particle are crosslinked. Accordingly, a crosslinked liquid crystal polymer particle is obtained. As a result, the monodomain liquid crystal structure of the liquid crystal polymer particle has a crosslinked structure.

The light or heat that generates an acid may be applied to a solution in which the non-crosslinked liquid crystal polymer particles are dispersed. Alternatively, the light or heat that generates an acid may be applied to the non-crosslinked liquid crystal polymer particles obtained by removing, from a solution in which the non-crosslinked liquid crystal polymer particles are dispersed, the solution through evaporation or the like. In each case, the acid generator has been introduced in each non-crosslinked liquid crystal polymer particle. Therefore, an acid is generated in the non-crosslinked liquid crystal polymer particle by energy (e.g., light or heat) that generates the acid, whereby the crosslinking reaction can be caused to occur.

### <3. First Production Example of Liquid Crystal Polymer Particle>

In the following, a first production example (experimental example) of the cholesteric liquid crystal polymer particle will be described. First, a mixture of the liquid crystalline monomer, the crosslinking agent, the chiral agent, the dispersion stabilizer, and the polymerization initiator (thermal polymerization initiator) shown in FIG. 2 was dissolved in a solvent to obtain a polymerization solution. The molar ratio of the crosslinking agent to the liquid crystal monomer was set to 15 mol %. The molar ratio of the chiral agent to the liquid crystal monomer was set to 4 mol %. The molar ratio of the dispersion stabilizer to the liquid crystal monomer was set to 1×10² mol %. The molar ratio of the polymerization initiator to the liquid crystal monomer was set to 4 mol %.

As the solvent, a mixed solvent of a poor solvent and a good solvent for the polymer to be generated was used. Here, methanol (MeOH) was used as the poor solvent, and N,N-dimethylformamide (DMF) was used as the good solvent. The volume ratio between the poor solvent (MeOH) and the good solvent (DMF) was set to 3:4. In the polymerization solution, the liquid crystalline monomer, the crosslinking agent, the chiral agent, the dispersion stabilizer, and the polymerization initiator are all dissolved in the mixed solvent. That is, the polymerization solution is a homogeneous solution. Therefore, the polymerization solution before polymerization does not include droplets. The polymerization solution does not include a material that serves as a core material that defines the orientation of liquid crystals.

Oxygen was degassed from the polymerization solution through freeze-deaeration. Subsequently, a thermal polymerization reaction (dispersion polymerization reaction) was performed at 55° C. at a stirring rate of 120 rpm for 17 hours. 0.5 g of the reaction liquid was weighed out to be filtered by a 0.8 μm membrane filter, and was washed (removal of unreacted substance) with methanol. The obtained filtrate (particles) was redispersed in 8 mL of water, and the resultant matter was left at a liquid crystal temperature of 55° C. for annealing. Through the operations above, particles which were monodisperse and which were uniform in orientation axes (helical axes) were obtained. Then, the solution was cast on a substrate (glass, etc.) and was subjected to evaporation at 5° C., whereby particles in a powder form were obtained.

The particles obtained through the operations above were subjected to proton nuclear magnetic resonance (¹H NMR) measurement, and it was confirmed that an oxetane group (oxetane ring) being a crosslinkable functional group had been introduced into the particles (in the polymer). In the first production example, confirmation that the oxetane group has been introduced and operations necessary for the confirmation may be omitted.

The chemical structure of the obtained particles (non-crosslinked liquid crystal polymer particles) is as shown in FIG. 2 and FIG. 4. A number-average molecular weight Mn of the polymer shown in FIG. 2 and FIG. 4 is 2.0×10⁴, and the molecular weight distribution (weight-average molecular weight Mw/number-average molecular weight Mn) is 2. A glass transition temperature Tg of the obtained particles is 33° C. during heating and 30° C. during cooling. A phase transition temperature T_{Cho→I} of the obtained particles is 81° C. during heating and 80° C. during cooling. The phase transition temperature T_{Cho→I} here is the phase transition temperature from a cholesteric phase Cho to an isotropic phase I.

After the confirmation that the oxetane group had been introduced, the above particles (non-crosslinked liquid crystal polymer particles) were redispersed in a solution containing an initiator for the crosslinking reaction, whereby a composition to be used in the crosslinking reaction was generated. Here, the solution was obtained by redispersing, into a solvent, a sulfonium-salt-based photoacid generator as the initiator for the crosslinking reaction. As the solvent, methanol (MeOH) being a poor solvent for the non-crosslinked liquid crystal polymer particles was used. Methanol is suitable since the solubility of the photoacid generator is large. In addition, the active species is cation and there is no bimolecular termination reaction. Thus, the amount of the photoacid generator was set to be close to the solubility of methanol. In the first production example, the composition to be used in the crosslinking reaction was composed of 400 mg of methanol, 4.0 mg of the photoacid generator, and 1.0 mg of the liquid crystal polymer particles. In order to introduce a crosslinking reaction diffusing agent into the non-crosslinked liquid crystal polymer particles, the temperature was set to 25° C., and the composition to be used in the crosslinking reaction was stirred at 300 rpm for 18 hours.

Then, for the crosslinking reaction, ultraviolet light (wavelength: 365 mm) was applied to the non-crosslinked liquid crystal polymer particles. More specifically, the composition to be used in the crosslinking reaction was cast on a glass substrate, methanol was evaporated (25° C., 5 minutes), and then, ultraviolet light was applied from directly above the glass substrate. The illuminance of the ultraviolet light was set to 0.02 mW/cm². The temperature during the light application was set to 25° C., and the light application time was set to 20 minutes. The crosslinking reaction here is a reaction that utilizes ring-opening of the oxetane group. Due to the ultraviolet light application, ring-opening of the oxetane group occurs, and a crosslinked structure is formed. It is not necessary to first cast the composition to be used in the crosslinking reaction onto the glass substrate, and then cause the crosslinking reaction. For example, the crosslinking reaction may be caused to occur in the non-crosslinked liquid crystal polymer particles in a methanol dispersion.

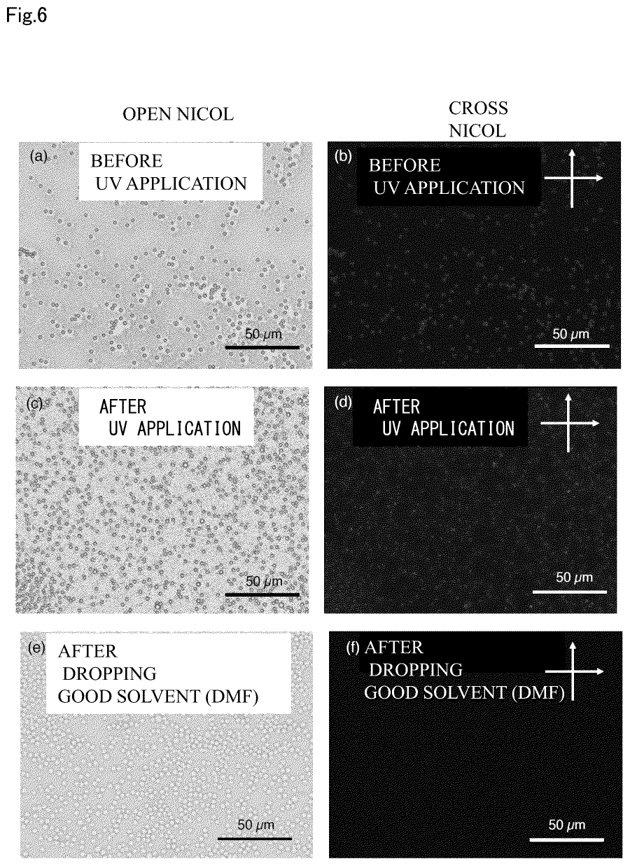

FIG. 6 shows observation images of polymer particles synthesized as described above. The observation of the polymer particles was performed by using a polarized optical microscope (POM). In FIG. 6, (a) and (b) show polymer particles before the ultraviolet light (UV) application for the crosslinking reaction. (c) and (d) show particles after the ultraviolet light (UV) application for the crosslinking reaction. (e) and (f) show polymer particles obtained by dropping DMF as a good solvent for the non-crosslinked liquid crystal polymer particles onto polymer particles after the ultraviolet light (UV) application for the crosslinking reaction. In FIG. 6, (a), (c), and (e) are open nicol observation images, and (b), (d), and (f) are cross nicol observation images.

From the open nicol observation image in FIG. 6(a), it is understood that, before the ultraviolet light (UV) application for the crosslinking reaction, polymer particles having a particle diameter of about 2 μm were obtained. In addition, it is understood that these polymer particles are uniform in particle diameter and are monodisperse. From the cross nicol observation image in FIG. 6(b), a cross-shaped dark field was able to be confirmed from each of the polymer particles having a particle diameter of about 2 μm. Therefore, it was able to be confirmed that the polymer particles having a particle diameter of about 2 μm were liquid crystal polymer particles having a monodomain liquid crystal structure having a predetermined liquid crystal orientation. It was confirmed that, although the photoacid generator had been introduced in these liquid crystal polymer particles, the introduction of the photoacid generator did not cause disturbance of the liquid crystal orientation. In FIG. 6(a), still finer particles are present around the liquid crystal polymer particles having a particle diameter of about 2 μm. Since double refraction was not observed from these fine particles, these fine particles are considered to be the photoacid generator.

From the open nicol observation image in FIG. 6(c), it was able to be confirmed that, also after the ultraviolet light (UV) application for the crosslinking reaction, the liquid crystal polymer particles having a particle diameter of about 2 μm maintained the shape and size thereof. In the cross nicol observation image in FIG. 6(d) as well, a cross-shaped dark field was able to be confirmed as before the ultraviolet light (UV) application. Therefore, it was able to be confirmed that the liquid crystal orientation was maintained also after the UV application. That is, the particles after the UV application are liquid crystal polymer particles that are monodisperse and that have a monodomain liquid crystal structure.

From the open nicol observation image in FIG. 6(e), it is understood that, even when DMF as a good solvent for the non-crosslinked liquid crystal polymer particles is dropped, the polymer particles after the ultraviolet light (UV) application for the crosslinking reaction are not dissolved in the DMF. That is, it was confirmed that, in each polymer particle after the ultraviolet light (UV) application for the crosslinking reaction, a crosslinked structure was formed. The crosslinked liquid crystal polymer particle has chemical resistance of not being dissolved in DMF. The liquid crystal polymer particles in FIG. 6(e) are swollen by DMF, and have slightly increased particle diameters. In the cross nicol observation image in FIG. 6(f), double refraction in the liquid crystal polymer particle was not able to be confirmed. This is because the orientation of the liquid crystal molecules became isotropic due to the swell caused by the solvent. When the solvent is evaporated, the swell is eliminated, and a cross-shaped dark field can be observed as in FIG. 6(d).

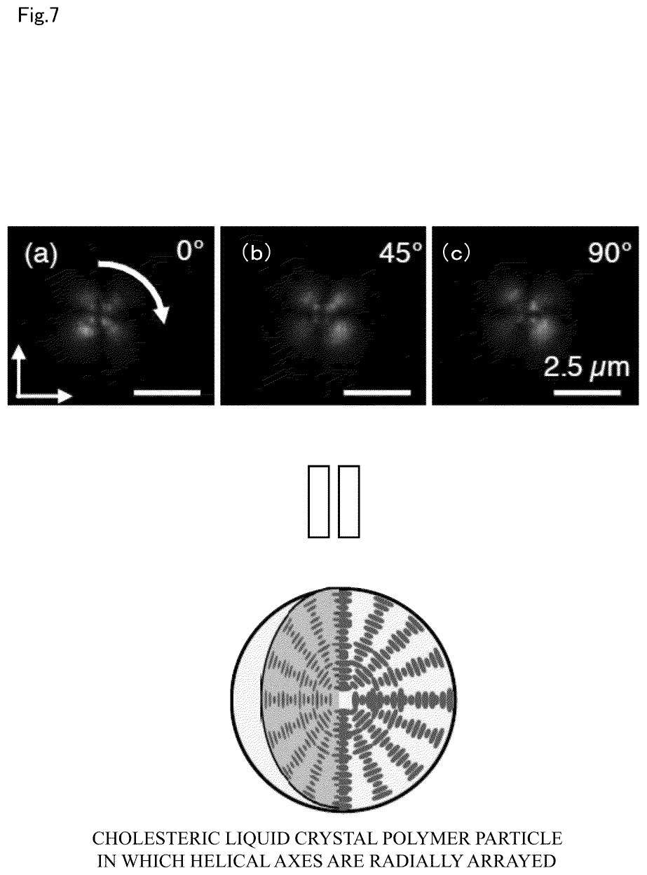

FIGS. 7(a), (b), and (c) show a crosslinked liquid crystal polymer particle shown in FIG. 6(d), with the sample stage of the polarized optical microscope rotated. When the state in FIG. 7(a) is defined as 0°, FIG. 7(b) shows a state rotated by 45° clockwise, and FIG. 7(c) shows a state rotated by 90° clockwise. Even when the sample stage was rotated, the cross-shaped dark field pattern did not change.

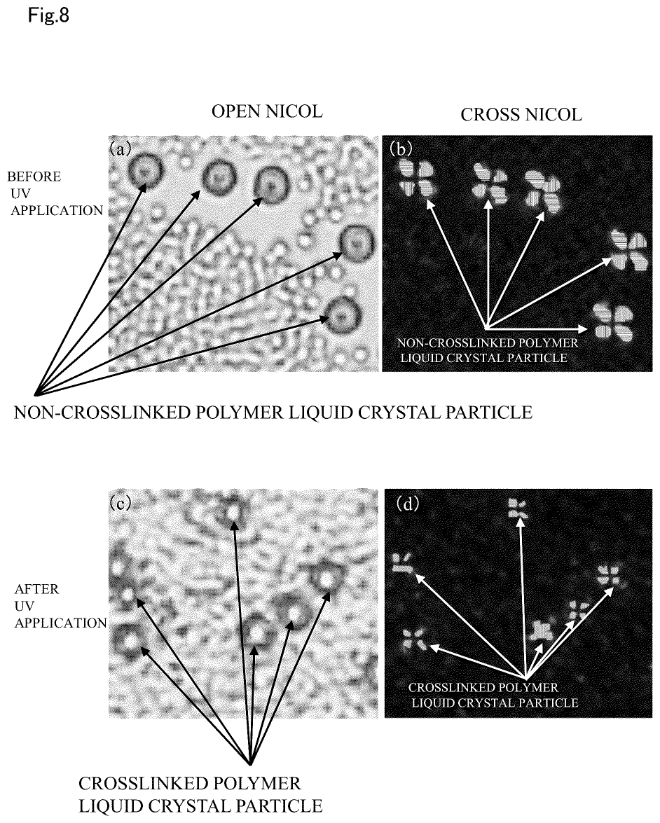

A sensitive color test plate whose retardation is known (R=530 mm) was inserted at +45° with respect to the polarizer of the polarized optical microscope, and particles before and after the ultraviolet light application were observed. FIG. 8 shows the result. When the optical axis of the sensitive color test plate and the orientation direction in the particle are aligned in parallel, the apparent color seems to be blue due to color addition. When the optical axis of the sensitive color test plate is perpendicular to the orientation direction in the particle, color seems to be yellow due to color subtraction. In the cross nicol observation images in FIG. 8, in order to ensure visibility in the black-and-white image, color-subtracted portions (yellow portion) in the particles are indicated by a vertical stripe pattern, and color-added portions (blue portion) in the particles are indicated by a horizontal stripe pattern.

In FIG. 8, for both before and after the UV application, regions at the upper right and the lower left with respect to the particle center exhibited color subtraction effect (yellow; vertical stripe), and regions at the upper left and the lower right exhibited color addition effect (blue; horizontal stripe).

From the results shown in FIG. 7 and FIG. 8, it was confirmed that, in both before and after the UV application, the particle has, in the inside thereof, a monodomain liquid crystal structure in which liquid crystal molecules are oriented in parallel to the particle interface and the cholesteric liquid crystal helical axes are radially arrayed. In the liquid crystal polymer particle in which the helical axes are radially oriented, reflection color is not dependent on the angle of visibility. However, reflection color changes when the helical pitch changes in response to a mechanical stimulation (e.g., pressing force or tensile force) applied to the particle. Therefore, with the crosslinked liquid crystal polymer particle according to the embodiment, strain caused by a mechanical stimulation can be monitored as reflection color change, without being dependent on the angle of visibility. The responsiveness to the mechanical stimulation (e.g., pressing force or tensile force) is dependent on the elasticity of the particle, for example. The elasticity of the particle can be adjusted by the degree of crosslinking.

In this first production example, the temperature at which the crosslinking reaction was performed was 25° C., which is not greater than the glass transition temperature Tg of the polymer particle, and the crosslinking reaction advanced without consideration of the motion of the polymer backbone. The following two factors are considered to be the reason. First, methanol remained in the polymer particle and this acted as a plasticizer, whereby mobility of the polymer backbone was improved. Second, the oxetane group is away from the polymer backbone (the chain length of the spacer: 6) and can move independently of the polymer backbone.

The ultraviolet light application for the crosslinking reaction was also performed in a state where the non-crosslinked liquid crystal polymer particles were present in the solution. In this case as well, results similar to the results shown in FIG. 6 to FIG. 8 were obtained. That is, it was confirmed that the crosslinking reaction advances also in a state where the non-crosslinked liquid crystal polymer particles are dispersed in the solution. In addition, also when an acid such as hydrochloric acid is used as the crosslinking reaction initiator, results similar to the results shown in FIG. 6 to FIG. 8 are obtained. Use of an acid instead of an acid generator is advantageous in industrial production of the particles as compared with a case where an acid generator is used.

### <4. Liquid Crystal Polymer Particle According to Reference Example>

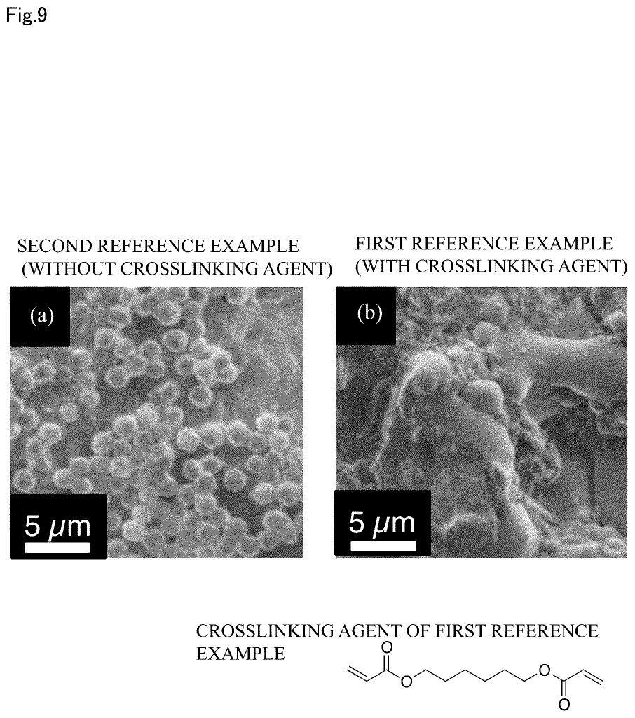

In the following, a method for producing liquid crystal polymer particles according to a first reference example and a second reference example will be described. In order to produce the liquid crystal polymer particle according to the first reference example, a mixture of the liquid crystalline monomer, the dispersion stabilizer, and the polymerization initiator shown in FIG. 2, and a crosslinking agent having the chemical structure shown in FIG. 9 was dissolved in a solvent to obtain a first polymerization solution. The molar ratio of the crosslinking agent to the liquid crystal monomer was set to 3 mol %, the molar ratio of the dispersion stabilizer to the liquid crystal monomer was set to 1×10² mol %, and the molar ratio of the polymerization initiator to the liquid crystal monomer was set to 4 mol %. As the solvent, a mixed solvent of methanol (MeOH) and N,N-dimethylformamide (DMF) was used. Methanol and DMF were mixed at a volume ratio of 1:1.

The crosslinking agent shown in FIG. 9 includes a spacer composed of an alkylene chain, and includes, at both ends of the molecular structure, an acrylate group as the second polymerizable group for polymerization reaction. In the crosslinking agent shown in FIG. 9, the polymerizable group that is involved in the polymerization reaction in which polymer particles are formed also serves as a functional group (crosslinkable functional group) for crosslinking reaction. Therefore, the polymerization reaction in which the polymer particles are formed is a crosslinking polymerization reaction in which the crosslinking reaction simultaneously advances.

A second polymerization solution for the second reference example was prepared in a similar manner to that for the first polymerization solution except that the crosslinking agent shown in FIG. 9 was not included. In the first reference example and the second reference example, the chiral agent was omitted since influence thereof is small.

Oxygen was degassed from each of the first polymerization solution and the second polymerization solution through freeze-deaeration. Subsequently, for each of the first polymerization solution and the second polymerization solution, a polymerization reaction (dispersion polymerization reaction) was performed at 55° C. at a stirring rate of 120 rpm for 17 hours. 0.5 g of the reaction liquid was weighed out to be filtered by a 0.8 μm membrane filter, and was washed (removal of unreacted substance) with methanol. Through the operations above, the liquid crystal polymer particles according to the first reference example were obtained from the first polymerization solution and the liquid crystal polymer particles according to the second reference example were obtained from the second polymerization solution. FIG. 9 shows results of observation, by a scanning electron microscope (SEM), of the first reference example and the second reference example each cast on a glass substrate.

In the second reference example obtained by causing the polymerization reaction in the second polymerization solution not including the crosslinking agent, monodisperse polymer particles having a particle diameter of about 2 μm were obtained, as in FIG. 6(a). Meanwhile, in the first reference example obtained by causing the polymerization reaction in the first polymerization solution including the crosslinking agent, liquid crystal polymers were aggregated through crosslinking, and as compared with the second reference example, the size was larger and the shape was also ununiform.

In the second reference example, the monomer uniformly dissolved in the solvent forms a polymer (primary particle) through polymerization, and then becomes insoluble in the solvent to be deposited. The deposited polymer (primary particle) serves as a particle nucleus, whereby the primary particle grows and a particle shape is formed (particle-growth-type polymerization). As a result, monodisperse liquid crystal polymer particles uniform in particle diameter are obtained. In contrast to this, in the first reference example, the crosslinking agent is crosslinked by the functional group that reacts in the polymerization reaction, and thus, when the primary particle deposited in the solvent grows through the polymerization reaction, the crosslinking agent is simultaneously crosslinked, which leads to excessive binding between liquid crystal polymers. That is, since particles are bound to each other through the crosslinking during growth thereof, the size of the particle becomes large and the shape thereof is lost. Further, in association with the crosslinking, the liquid crystal orientation is also disturbed.

As described above, when liquid crystal polymer particles are synthesized through a crosslinking polymerization reaction in which polymerization and crosslinking occur in parallel, the liquid crystal molecular orientation property of each liquid crystal polymer particle may decrease and monodispersity thereof may decrease. In contrast to this, through two steps in which non-crosslinked liquid crystal polymer particles are synthesized in advance through a polymerization reaction and then are subjected to crosslinking through a crosslinking reaction thereafter, decrease in the liquid crystal molecular orientation property or monodispersity of each liquid crystal polymer particle can be suppressed.

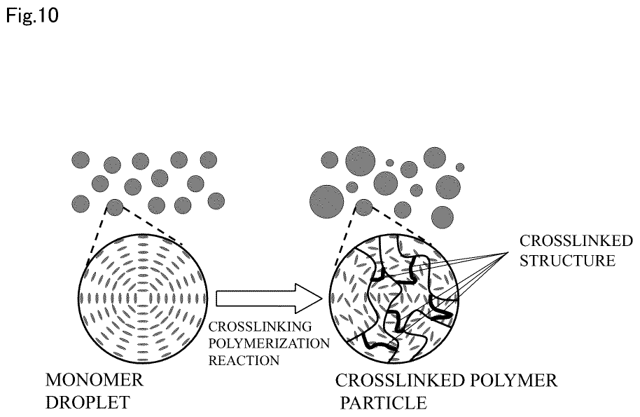

The problem of decrease in the liquid crystal molecular orientation property or monodispersity occurs not only in the first reference example which is a particle-growth-type polymerization, but also in a droplet polymerization type as shown in FIG. 10. The droplet polymerization type is a synthesis method in which a droplet (monomer droplet) of the polymerization solution is directly polymerized to be a liquid crystal polymer particle. The droplet (monomer droplet) is formed by a microchannel method or through suspension, for example. When a monomer droplet is subjected to crosslinking a polymerization reaction in which polymerization and crosslinking occur in one step, the liquid crystal molecular orientation property and monodispersity decrease in association with the crosslinking reaction, as shown in FIG. 10.

### <5. Second Production Example of Liquid Crystal Polymer Particle>

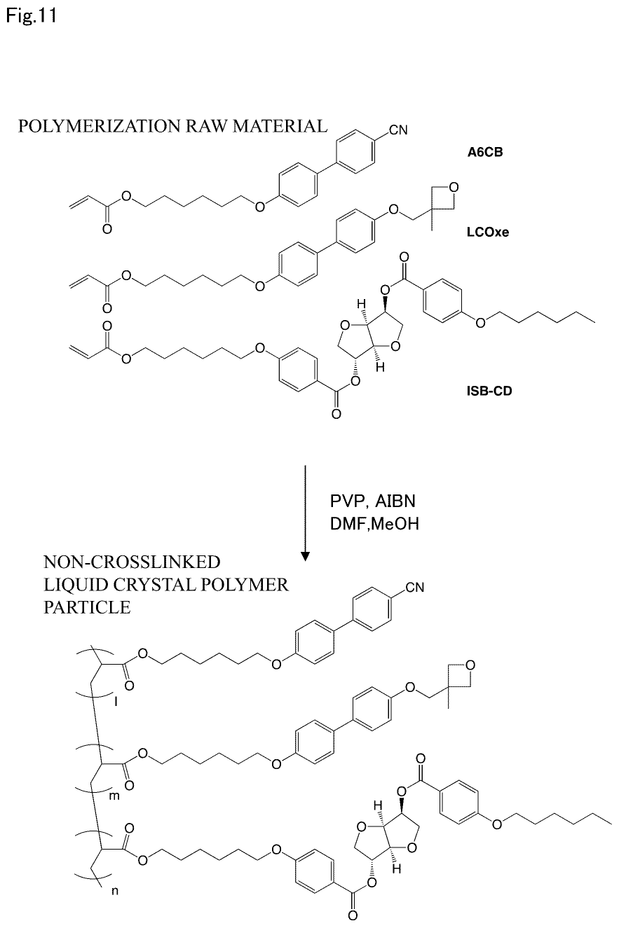

In the following, a second production example of the cholesteric liquid crystal polymer particle will be described. In the second production example, a liquid crystalline monomer (A6CB), a crosslinking agent (LCOxe), and a chiral monomer (ISB-CD) having the chemical structures shown in FIG. 11 are used as the polymerization raw materials. In the second production example, the crosslinking agent includes a mesogenic group. The mesogenic group is a biphenyl group, as an example. In the crosslinking agent shown in FIG. 11, biphenyl to serve as the mesogenic group is incorporated in the spacer moiety. l, m, and n in the polymer backbone in FIG. 11 may correspond to the numbers of repetition n₁, n₂, and n₃ of P₁, P₂, and P₃ in formula (2), respectively.

The liquid crystalline monomer (A6CB), the crosslinking agent (LCOxe), and the chiral monomer (ISB-CD) which are the polymerization raw materials are dissolved in a solvent together with polyvinyl pyrrolidone (PVP (K-30)) as the dispersion stabilizer and azobisisobutyronitrile (AIBN) as the polymerization initiator, whereby a polymerization solution is prepared (step 11 in FIG. 1). The solvent in which the polymerization raw materials are dissolved is a mixture of N,N-dimethylformamide (DMF) and methanol (MeOH), as an example.

Using the prepared polymerization raw materials, non-crosslinked polymers were generated (step S12 in FIG. 1) and the non-crosslinked polymers were crosslinked (step S13 in FIG. 1), in accordance with the procedure similar to that in the first production example.

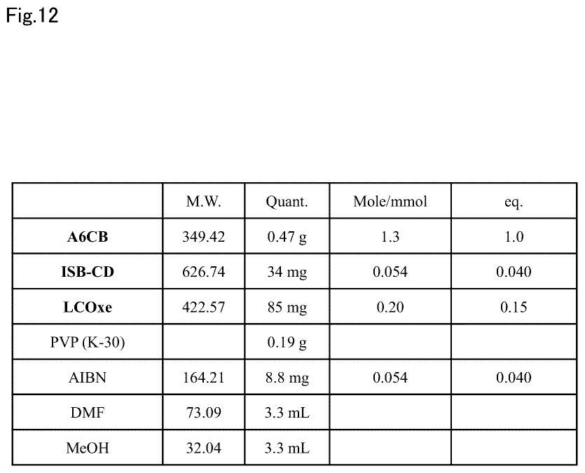

FIG. 12 shows compositions of the polymerization raw materials and the solvent in the second production example. In FIG. 12, “M.W.” represents weight-average molecular weight, “Quant.” represents Quantitative (amount), and “eq.” represents Equivalent (chemical equivalent). A number-average molecular weight Mn of the polymer synthesized with the composition shown in FIG. 12 is 1.9×10⁴, and the molecular weight distribution (weight-average molecular weight Mw//number-average molecular weight Mn) is 3.3. From a result of nuclear magnetic resonance (NMR) measurement, the copolymerization ratio was A6CB:LCOXe:ISB-CD=85:12:3. A glass transition temperature Tg of the obtained particles is 38° C. The obtained particles exhibited a smectic liquid crystal phase. A phase transition temperature T_{Sm→I} of the obtained particles is 120° C. during heating and 121° C. during cooling. The phase transition temperature T_{Sm→1} here is the phase transition temperature from a smectic liquid crystal phase Sm to an isotropic phase I.

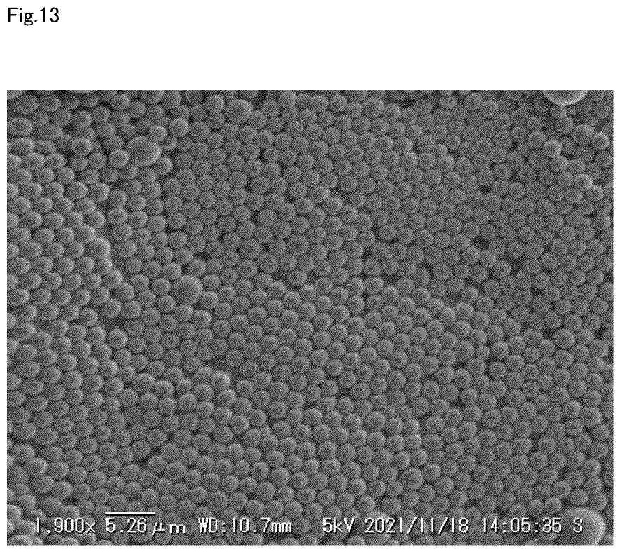

FIG. 13 shows an electron microscope (SEM) image of the polymer particles (crosslinked liquid crystal polymer particles) produced in the second production example. In the second production example as well, monodisperse particles were obtained. The average particle diameter of the particles was 2.0 μm. Thus, also when the crosslinking agent (LCOxe) having a mesogenic group is used, monodisperse particles are obtained as in the first production example.

### <6. Third Production Example of Liquid Crystal Polymer Particle>

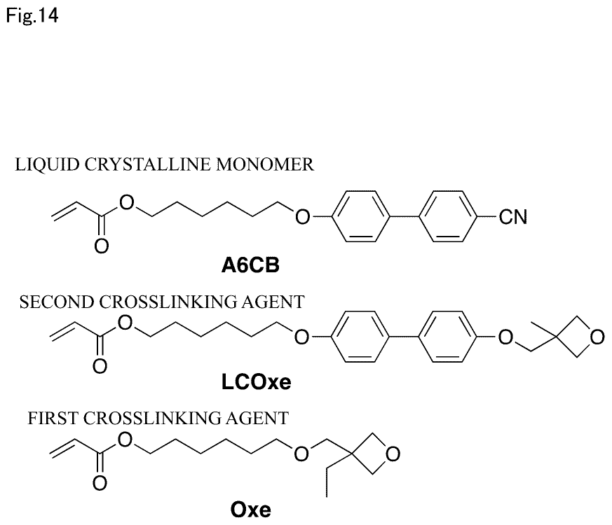

As shown in FIG. 14, in a third production example, both of a first crosslinking agent (Oxe) and a second crosslinking agent (LCOxe) were used as the crosslinking agent. The first crosslinking agent is the crosslinking agent (see Oxe: FIG. 2) used in the first production example. The second crosslinking agent is the crosslinking agent (LCOxe) used in the second production example. In the third production example, the liquid crystal monomer (A6CB) as in the first and the second production examples was used as the liquid crystal monomer. In the third production example, no chiral monomer was used.

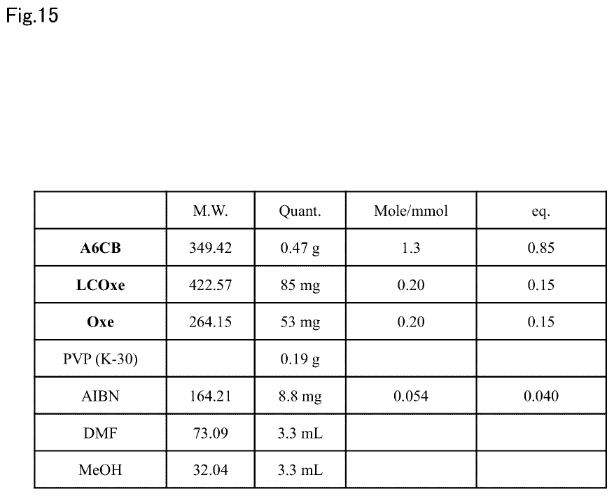

In the third production example, particles were produced in the same manner as in the first and the second production examples except that both of the first crosslinking agent (Oxe) and the second crosslinking agent (LCOxe) were used as the crosslinking agent, and no chiral monomer was used. FIG. 15 shows compositions of the polymerization raw materials and the solvent in the third production example. From a result of NMR measurement, the copolymerization ratio of the particles obtained in the third production example was A6CB:LCOxe:Oxe=77:13:10.

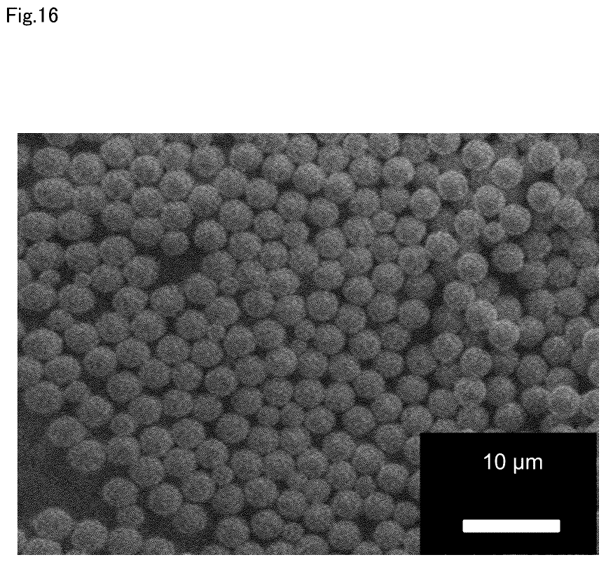

FIG. 16 shows an electron microscope (SEM) image of the polymer particles (crosslinked liquid crystal polymer particles) produced in the third production example. In the third production example as well, monodisperse particles were obtained. The average particle diameter of the particles was 3.6 μm. Thus, in the third production example as well, monodisperse particles are obtained as in the first and the second production examples.

### <7. Example of Crosslinking Method>

### <7.1 First Crosslinking Example: Photoacid Generator>

Unlike the first production example, it is not necessary to first cast the composition (particle) to be used in the crosslinking reaction onto a glass substrate, and then cause the crosslinking reaction. In the following, an example in which the crosslinking reaction is caused to occur in a dispersion (methanol) of particles will be described.

In a first crosslinking example, up to the confirmation, in the first production example, that the oxetane group had been introduced, a procedure similar to that of the first production example was followed. After the confirmation that the oxetane group had been introduced, the non-crosslinked liquid crystal polymer particles were redispersed in a solution containing an initiator for the crosslinking reaction, whereby a composition to be used in the crosslinking reaction was generated. Here, the photoacid generator and the non-crosslinked liquid crystal polymer particles that were used were the same as those in the first production example. In the first crosslinking example, changes from the first production example are the concentration of the photoacid generator and the particles. It is considered that, when the particle concentration is large, scattering of light is strong, ultraviolet light does not permeate, and thus, the photoacid generator is not sufficiently cleaved. Therefore, 1.0 mg of the photoacid generator was mixed into 10 g of methanol, and then 5.0 mg of the particles was dispersed therein, whereby a dispersion to be used in the crosslinking reaction was prepared.

Then, for the crosslinking reaction, while the particle dispersion was being stirred at 300 rpm, ultraviolet light (wavelength: 365 mm) was applied to the non-crosslinked liquid crystal polymer particles. The temperature at this time was 25° C. The illuminance of the ultraviolet light was set to 45 mW/cm². After ultraviolet light was applied for one hour, light application was stopped, and stirring was performed further for one hour, whereby the crosslinking reaction was completed.

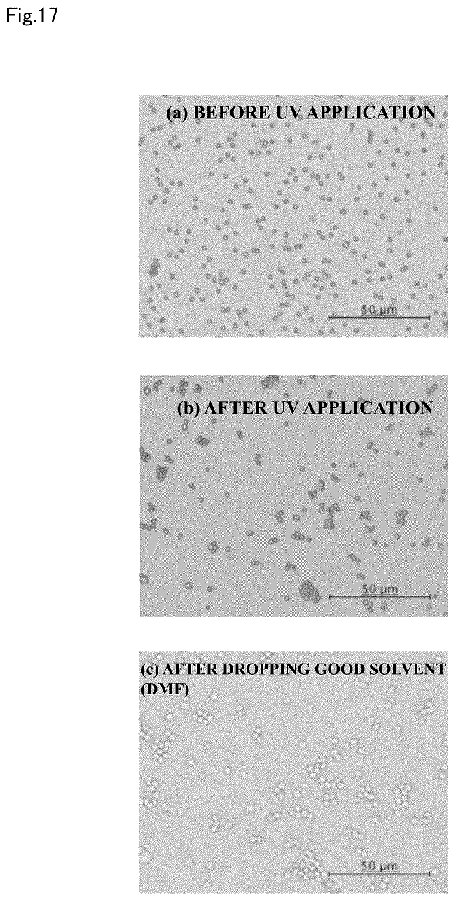

FIG. 17 shows results of polarized optical microscope observation with open nicol of the liquid crystal polymer particles produced in the first crosslinking example. In FIG. 17, (a) shows polymer particles before the ultraviolet light (UV) application for the crosslinking reaction. (b) shows particles after the ultraviolet light (UV) application for the crosslinking reaction. (c) shows polymer particles obtained by dropping DMF as a good solvent for the non-crosslinked liquid crystal polymer particles onto polymer particles after the ultraviolet light (UV) application for the crosslinking reaction. Similar to the first production example, it is understood that, even when DMF as a good solvent for the non-crosslinked liquid crystal polymer particles is dropped, the polymer particles after the ultraviolet light (UV) application for the crosslinking reaction are not dissolved in the DMF. That is, it was confirmed that, in each polymer particle after the ultraviolet light (UV) application for the crosslinking reaction, a crosslinked structure was formed.

### <7.2 Second Crosslinking Example: Crosslinking Using Lewis Acid Catalyst>

In a second crosslinking example, aluminum chloride as a Lewis acid catalyst was used to synthesize crosslinked particles. Crosslinking using an acid is advantageous since ultraviolet light is not required as compared with crosslinking using a photoacid generator. When a photoacid generator is used, it is necessary to cause ultraviolet light to sufficiently permeate, and thus, the particle dispersion needs to be dilute. Therefore, in some cases, use of a photoacid generator is not suitable for crosslinking in a large scale. In contrast to this, crosslinking using an acid and not requiring a photoacid generator is suitable for a large scale, and is advantageous in terms of industrialization.

In the second crosslinking example, a dispersion in which 1.0 mg of the non-crosslinked particles obtained in the first production example was dispersed in 0.3 g of methanol was prepared. 10 mg of aluminum chloride as the Lewis acid catalyst was added to the dispersion, and the resultant matter was stirred at 25° C. for 24 hours.

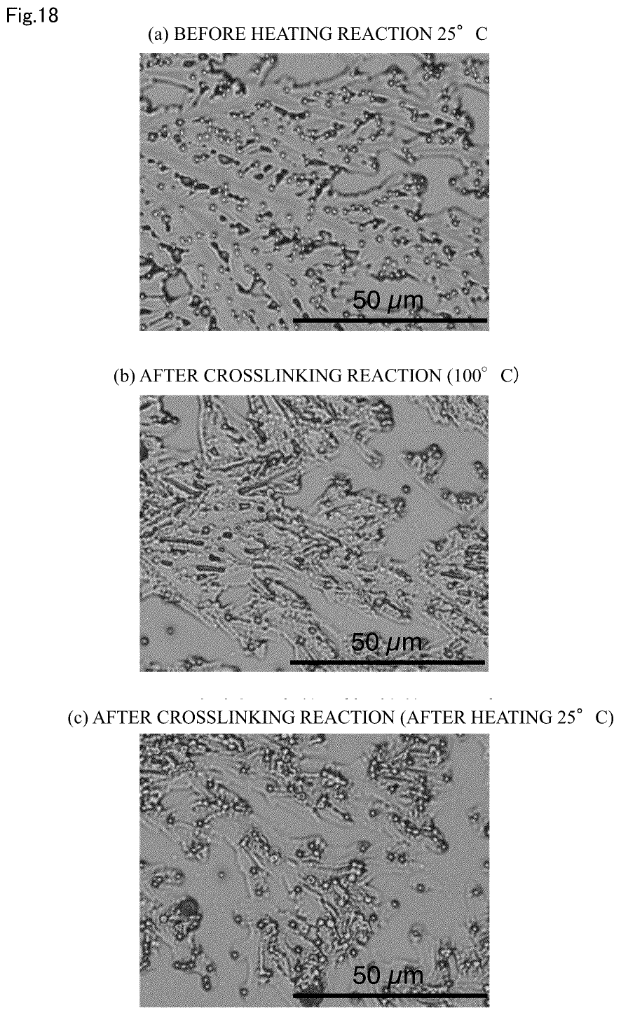

FIG. 18 shows results of polarized optical microscope observation with open nicol of the crosslinked liquid crystal polymer particles obtained in the second crosslinking example. In FIG. 18, (a) shows particles before being crosslinked, (b) shows particles (100° C.) after the crosslinking reaction, and (c) shows particles obtained by cooling the particles in (b) to 25° C. In FIG. 18, the film-like substance in the background is considered to be aluminum hydroxide as a byproduct of the catalyst. As shown in FIG. 18(b), even when the particles having been crosslinked were heated to 100° C. as the isotropic phase temperature, all of the particles were present, with the shape thereof maintained. From this result, it is determined that the crosslinking reaction advanced. Therefore, even under a condition where the particles are at a relatively high concentration, crosslinking was successfully performed.

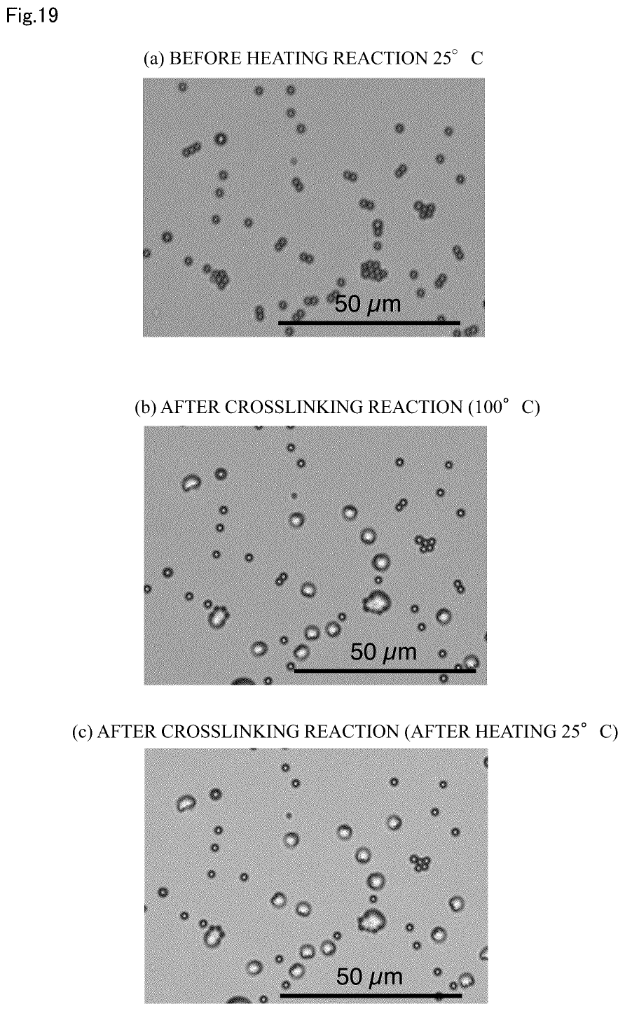

FIG. 19 shows results of polarized optical microscope observation with open nicol of the crosslinked liquid crystal polymer particles obtained in a third crosslinking example. The third crosslinking example was the same as the second crosslinking example except that the amount of aluminum chloride was set to be small, i.e., 1.0 mg. In FIG. 19, (a) shows particles before being crosslinked, (b) shows particles (100° C.) after the crosslinking reaction, and (c) shows particles obtained by cooling the particles in (b) to 25° C. As shown in FIG. 19, in the third crosslinking example, since the amount of aluminum chloride was small, the crosslinking reaction of the particles was insufficient, and particles were fused to each other by heating.

### <5. Additional Note>

The present invention is not limited to the above examples, and various modifications can be made.

1: A liquid crystal polymer particle comprising:
a crosslinked structure in which liquid crystal polymers are crosslinked by a crosslinkable functional group that is not crosslinked in a polymerization reaction for synthesizing the liquid crystal polymer particle.

2: The liquid crystal polymer particle according to claim 1, wherein
each liquid crystal polymer includes:
a polymer backbone;
a first side chain bound to the polymer backbone; and
a second side chain bound to the polymer backbone,
the first side chain includes a first mesogenic moiety, and
the second side chain includes a crosslinking moiety forming the crosslinked structure.

3: The liquid crystal polymer particle according to claim 2, wherein
the second side chain further includes a second mesogenic moiety between the crosslinking moiety and the polymer backbone.

4: The liquid crystal polymer particle according to claim 2, wherein
the liquid crystal polymer further includes a third side chain bound to the polymer backbone, and
the third side chain includes a chiral moiety.

5: The liquid crystal polymer particle according to claim 1, wherein
the liquid crystal polymer particle is a monodisperse particle.

6: The liquid crystal polymer particle according to claim 1, wherein
the liquid crystal polymer particle is a cholesteric liquid crystal polymer particle.

7: The liquid crystal polymer particle according to claim 6, wherein
the cholesteric liquid crystal polymer particle has a structure in which helical axes are radially oriented from a particle center.

8: The liquid crystal polymer particle according to claim 1, wherein
the crosslinked structure comprises a structure in which a liquid crystal polymer represented by formula (1) below is crosslinked by a crosslinkable functional group below, 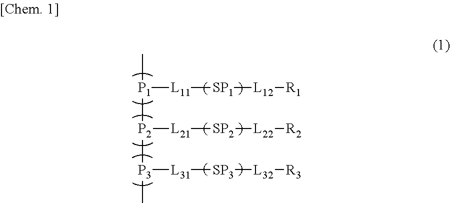
where, in formula (1),
P₁, P₂, and P₃ are each a repeating unit forming a polymer backbone generated through polymerization of any one selected from the group consisting of a vinyl group, an acrylic group, and a methacrylic group,
L₁₁, L₁₂, L₂₁, L₂₂, L₃₁, and L₃₂ are each independently a divalent linking group or a single bond,
SP₁, SP₂, and SP₃ are each a spacer group or a single bond,
R₁ is a mesogenic group,
R₂ is any one crosslinkable functional group selected from the group consisting of an oxetane group, an epoxy group, a vinyl ether group, and a derivative thereof, and
R₃ is a chiral group.

9: The liquid crystal polymer particle according to claim 1, wherein
the crosslinked structure comprises a structure in which a liquid crystal polymer represented by formula (1) below is crosslinked by a crosslinkable functional group below, 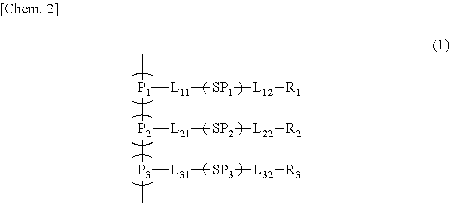
where, in formula (1),
P₁, P₂, and P₃ are each a repeating unit forming a polymer backbone,
L₁₁, L₁₂, L₂₁, L₂₂, L₃₁, and L₃₂ are each independently a divalent linking group or a single bond,
SP₁, SP₂, and SP₃ are each a spacer group or a single bond,
R₁ is a mesogenic group,
R₂ is a crosslinkable functional group having a reactivity different from that of the repeating unit, and
R₃ is a chiral group.

10: The liquid crystal polymer particle according to claim 1, wherein
the crosslinked structure comprises a structure in which a liquid crystal polymer represented by formula (1) below is crosslinked by a crosslinkable functional group below, 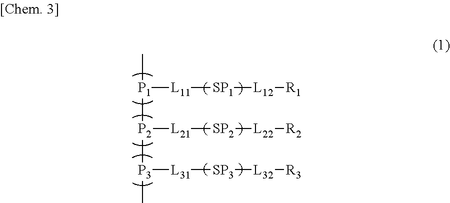
where, in formula (1),
P₁, P₂, and P₃ are each a repeating unit of a polymer backbone generated through polymerization of a radical polymerizable group,
L₁₁, L₁₂, L₂₁, L₂₂, L₃₁, and L₃₂ are each independently a divalent linking group or a single bond,
SP₁, SP₂, and SP₃ are each a spacer group or a single bond,
R₁ is a mesogenic group,
R₂ is a crosslinkable functional group for a ring-opening crosslinking reaction, and
R₃ is a chiral group.

11: The liquid crystal polymer particle according to claim 8, wherein
the mesogenic group is any one selected from the group consisting of a phenyl group, a biphenyl group, a phenylcyclohexyl group, a bicyclohexyl group, a phenyl benzoate group, an azobenzene group, a tolane group, a derivative thereof, and a complex thereof.

12: The liquid crystal polymer particle according to a claim 8, wherein
the divalent linking group is any one selected from the group consisting of —O—, —C(═O)O—, —OC(═O)—, —C(═O)NH—, a phenylene group, a divalent group of a mesogen, and a combination of two or more thereof.

13: The liquid crystal polymer particle according to claim 8, wherein
the spacer group is any one selected from the group consisting of an alkylene group, an oxyalkylene group, a silylene group, and an oxysilylene group.

14: A method for producing a liquid crystal polymer particle, the method comprising:
generating a non-crosslinked liquid crystal polymer particle through a polymerization reaction; and
crosslinking, through a crosslinking reaction after the polymerization reaction, the non-crosslinked liquid crystal polymer particle generated through the polymerization reaction, wherein
the crosslinking reaction is a different-type-reactivity crosslinking reaction having a reactivity different from that of the polymerization reaction.

15: The method for producing the liquid crystal polymer particle according to claim 14, wherein
the non-crosslinked liquid crystal polymer particle has a functional group that is not crosslinked in the polymerization reaction and that is crosslinked through the crosslinking reaction after the polymerization reaction.

16: The method for producing the liquid crystal polymer particle according to claim 14, wherein
the polymerization reaction is a polymerization reaction of:
a liquid crystalline monomer including a first polymerizable group that is polymerized in the polymerization reaction;
a polyfunctional crosslinking agent including a functional group that is not crosslinked in the polymerization reaction and a second polymerizable group that is polymerized in the polymerization reaction; and
a chiral monomer including a third polymerizable group that is polymerized in the polymerization reaction.

17: The method for producing the liquid crystal polymer particle according to claim 14, further comprising
introducing an initiator for the crosslinking reaction into the non-crosslinked liquid crystal polymer particle.

18: The method for producing the liquid crystal polymer particle according to claim 14, wherein
the crosslinking reaction is a reaction in which an acid or an acid generator is used as an initiator for the crosslinking reaction.

19: The method for producing the liquid crystal polymer particle according to claim 14, wherein
the non-crosslinked liquid crystal polymer particle is a cholesteric liquid crystal polymer particle.

20: The method for producing the liquid crystal polymer particle according to claim 14, wherein
the non-crosslinked liquid crystal polymer particle is a cholesteric liquid crystal polymer particle in which helical axes are radially oriented from a particle center.
